(19) United States
(12) Patent Application Publication
(10) Pub. No.: US 2017/0098267 A1
(43) Pub. Date: Apr. 6, 2017

(54) METHOD AND APPARATUS FOR PRODUCT PURCHASE PROCESSING

(71) Applicant: FUJITSU LIMITED, Kawasaki-shi (JP)

(72) Inventor: Toki Hokazono, Saitama (JP)

(73) Assignee: FUJITSU LIMITED, Kawasaki-shi (JP)

(21) Appl. No.: 15/271,906

(22) Filed: Sep. 21, 2016

(30) Foreign Application Priority Data
Oct. 2, 2015 (JP) 2015-196934

(51) Int. Cl. G06Q 30/06

(52) U.S. Cl. CPC G06Q 30/0627

(57) ABSTRACT

A storing unit stores identification information of each customer, an allergen, and allergen ingestion restriction information about a restriction on ingestion of the allergen in association with each other. A calculating unit acquires the identification information of a target customer and product information of one or more products for purchase by the customer. Then, with reference to memory content of the storing unit, the calculating unit acquires the allergen and allergen ingestion restriction information stored in association with the acquired identification information of the customer. When the acquired product information includes a specific product containing the allergen, the calculating unit outputs product intake restriction information about a restriction on intake of the product based on the allergen ingestion restriction information.

### CROSS-REFERENCE TO RELATED APPLICATION

This application is based upon and claims the benefit of priority of the prior Japanese Patent Application No. 2015-196934, filed on Oct. 2, 2015, the entire contents of which are incorporated herein by reference.

### FIELD

The embodiments discussed herein are related to a method and apparatus for product purchase processing.

### BACKGROUND

Intake of food is essential for people to sustain life and lead healthy lives. However, through intake of food, some people may develop hypersensitivity to allergic substances, called allergens, included in the food (allergic diseases). In view of this, mechanisms have been explored to prevent health hazards caused by food in serving meals and selling food products to customers. For example, a proposed technique is directed to a system for supporting food orders from menus at restaurants. The system manages hazardous food information indicating restricted food ingredients for each customer and issues a warning if a customer places an order for a dish which contains his/her restricted food ingredient.

There has been another proposed technique for supporting meal selection for an individual by determining dietary restrictions of the person for each meal according to the time of day. The dietary restrictions for each meal are determined based on the daily dietary restrictions on the intake of calories, salt content, sugar content, and cholesterol for the person as well as weighting according to the time of day.

See, for example, Japanese Laid-open Patent Publication Nos. 2005-222191 and 2008-204319.

### SUMMARY

According to an aspect, there is provided a product purchase processing method including acquiring identification information of a target customer and product information of one or more products for purchase by the target customer; specifying, with reference to customer information stored in a memory, an allergen and allergen ingestion restriction information about a restriction on ingestion of the allergen, the allergen and the allergen ingestion restriction information being stored in association with the identification information of the target customer; and outputting, when the one or more products include a product containing the allergen, product intake restriction information about a restriction on intake of the product based on the allergen ingestion restriction information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a product purchase processor according to a first embodiment;

FIG. 2 illustrates an example of a POS system according to a second embodiment;

FIG. 3 illustrates an example of peripherals of a POS terminal according to the second embodiment;

FIG. 4 illustrates an example of hardware of a management server according to the second embodiment;

FIG. 5 illustrates an example of hardware of the POS terminal according to the second embodiment;

FIG. 6 illustrates an example of functional components according to the second embodiment;

FIGS. 7A and 7B illustrate examples of tables according to the second embodiment;

FIG. 8 illustrates an example of a customer table according to the second embodiment;

FIG. 9 illustrates an example of a family member table according to the second embodiment;

FIG. 10 illustrates an example of an allergy management table according to the second embodiment;

FIG. 11 illustrates an example of a product master according to the second embodiment;

FIG. 12 illustrates an example of an allergy master according to the second embodiment;

FIG. 13 illustrates an example of an ingredient master according to the second embodiment;

FIG. 14 illustrates an example of a packaging master according to the second embodiment;

FIG. 15 illustrates a first example of a customer registration screen image according to the second embodiment;

FIG. 16 is a second example of the customer registration screen image according to the second embodiment;

FIG. 17 is a third example of the customer registration screen image according to the second embodiment;

FIG. 18 illustrates an example of a product master registration screen image according to the second embodiment;

FIG. 19 is an example of an allergy master registration screen image according to the second embodiment;

FIG. 20 is an example of a product registration screen image according to the second embodiment;

FIG. 21 illustrates a print sample of a receipt according to the second embodiment;

FIG. 22 is a flowchart illustrating an example of customer registration according to the second embodiment;

FIG. 23 is a flowchart illustrating an example of a POS process according to the second embodiment;

FIG. 24 is a flowchart illustrating an example of providing allergy information according to the second embodiment;

FIG. 25 illustrates another example of providing the allergy information according to the second embodiment;

FIG. 26 illustrates a first example of other systems according to the second embodiment;

FIG. 27 illustrates a second example of other systems according to the second embodiment;

FIG. 28 illustrates a third example of other systems according to the second embodiment;

FIG. 29 is a flowchart illustrating another example of the customer registration according to the second embodiment;

FIG. 30 is a flowchart illustrating an example of product registration according to the second embodiment;

FIG. 31 illustrates an example of functional components according to a third embodiment;

FIG. 32 illustrates an example of tables according to the third embodiment;

FIG. 33 is a flowchart illustrating an example of a POS process according to the third embodiment;

FIG. 34 illustrates an example of a nutritional component management table according to a fourth embodiment;

FIG. 35 illustrates an example of a nutritional component master according to the fourth embodiment;

FIG. 36 is a flowchart illustrating an example of providing nutritional component information according to the fourth embodiment; and

FIG. 37 illustrates a print sample of a receipt according to the fourth embodiment.

### DESCRIPTION OF EMBODIMENTS

Patients with food allergies are conventionally often directed not to eat any food containing their allergens. In response, it is conceivable that stores and shops selling food products provide, as part of customer care strategies, their customers with information on whether each product contains ingredients identified as allergens. However, recent studies show that it is not necessarily appropriate to subject patients to severe dietary restrictions. For example, it is not uncommon for children with allergic diseases to be improved or cured with maturity, and they are allowed to consume their targeted food products according to the course of treatment provided the amount is within acceptable intake limits. Allergic patients are able to learn the amount of acceptable intake of an allergen by taking food challenge tests at medical institutions and have meals adhering to the acceptable intake, thereby improving the quality of their lives. However, signs simply indicating “whether ingredients containing allergens are included or not” as in conventional technology are not sufficient for allergic patients to understand how much of each food product containing their allergens they are allowed to eat.

Several embodiments will be described below with reference to the accompanying drawings, wherein like reference numerals refer to like elements throughout.

### (a) First Embodiment

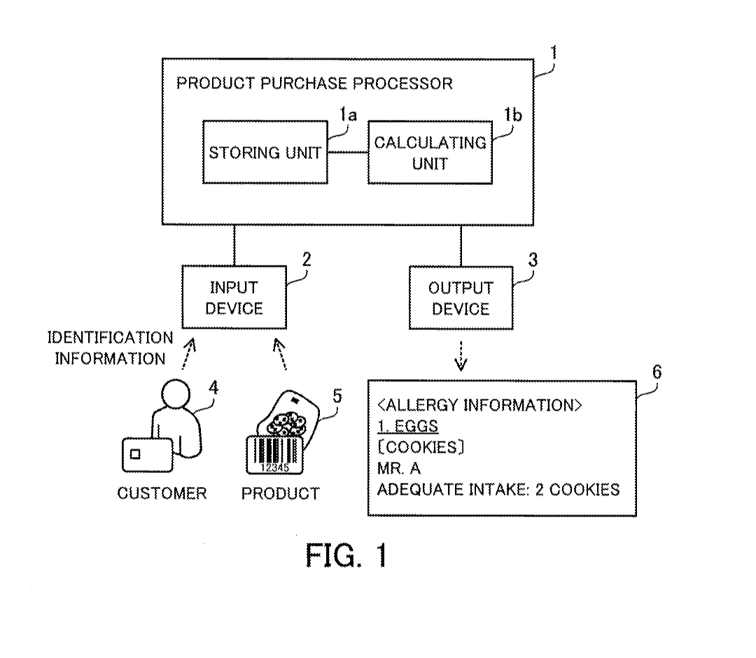

FIG. 1 illustrates a product purchase processor according to a first embodiment. A product purchase processor 1 supports users to purchase products. For example, the product purchase processor 1 may be a point-of-sales (POS) terminal installed at a shop, or an information processor for communicating with POS terminals and client terminals used by the users. In addition, the product purchase processor 1 may be a computer. The product purchase processor 1 is connected to, for example, an input device 2 and an output device 3. The input device receives an operation input from a user. The input device 2 may be a reader for reading an integrated circuit (IC) card owned by a customer 4 and also reading a barcode label or wireless tag on each product 5. The input device 2 may be an input unit such as a keyboard for receiving key operations or a touch panel for receiving touch signals. The output device 3 presents output from the product purchase processor 1 to the user. The output device 3 is, for example, a printer for printing text on paper, a display unit for displaying images, or a speaker for outputting audio.

The product purchase processor 1 includes a storing unit 1a and a calculating unit 1b. The storing unit 1a may be a volatile storage device such as random access memory (RAM), or a non-volatile storage device such as a hard disk drive (HDD) or flash memory. The calculating unit 1b may include, for example, a central processing unit (CPU), a digital signal processor (DSP), an application specific integrated circuit (ASIC), and a field programmable gate array (FPGA). The calculating unit 1b may be a processor for executing programs. The term “processor” here includes a set of multiple processors (i.e., multiprocessor).

The storing unit 1a stores therein identification information of each customer, an allergen, and information about a restriction on ingestion of the allergen (hereinafter simply referred to as the “ingestion restriction information on the allergen” or “allergen ingestion restriction information”) in association with each other. For example, the customer 4 is an allergic patient. By taking a food challenge test (also referred to as an “oral food challenge”) at a medical institution or the like, the customer 4 is able to preliminarily learn an allergen(s) for the customer 4 identified amongst a plurality of allergen candidates and the acceptable ingestion of the allergen per meal. For example, the product purchase processor 1 pre-stores, in the storing unit 1a, the allergen for the customer 4 and the acceptable ingestion of the allergen (i.e., the ingestion restriction information on the allergen) in association with the identification information of the customer 4.

In the case where, for example, a shop operates the product purchase processor 1, a system administrator of the shop may register, in the storing unit 1a, the allergen for the customer 4 and the ingestion restriction information on the allergen in association with the identification information of the customer 4 upon application of the customer 4. Alternatively, the customer 4 is allowed to register the allergen for the customer 4 and the allergen ingestion restriction information in the storing unit 1a. Assume here that the customer 4 is allergic to eggs. The storing unit 1a stores therein the allergen “eggs” and an acceptable egg intake of “10 g (grams)” per meal for the customer 4 in association with the identification information of the customer 4.

In addition, the storing unit 1a stores therein product information of each product. The product information includes identification information of the product, information on ingredients of the product, and information on the amount of each ingredient contained in the product. Assume here that the product 5 is cookies and eggs are contained as an ingredient in the cookies. The product information includes, for example, information indicating that the product is “cookies”; “eggs” are contained as an ingredient; and the amount of eggs per cookie is “5 g”.

The calculating unit 1b acquires identification information of a target customer and product information about one or more products for purchase by the customer. For example, using the input device 2, the customer 4 or a sale person at the shop is able to enter the identification information of the customer 4 and the identification information of the product 5 into the input device 2. The calculating unit 1b acquires the identification information of the customer 4 and the identification information of the product 5 entered from the input device 2 into the product purchase processor 1. Based on the identification information of the product 5, the calculating unit 1b acquires the product information of the product 5 from the storing unit 1a.

With reference to the content stored in the storing unit 1a, the calculating unit 1b acquires an allergen and ingestion restriction information on the allergen stored in association with acquired identification information of a target customer. For example, with reference to the content stored in the storing unit 1a, the calculating unit 1b acquires information indicating that the allergen is “eggs” and the acceptable egg intake is “10 g (grams)” stored in association with the identification information of the customer 4.

In the case where acquired product information about products for purchase by a target customer includes a particular product containing an allergen for the customer, the calculating unit 1b outputs information about a restriction on intake of the product based on ingestion restriction information on the allergen. For example, in the case where the product information about products for purchase by the customer 4 includes the product 5 containing the allergen for the customer 4, the calculating unit 1b outputs information about a restriction on intake of the product 5 (hereinafter sometimes referred to as the “allergy information”) based on the ingestion restriction information on the allergen. Note here that the allergy information output from the calculating unit 1b is referred to as allergy information 6.

The information stored in the storing unit 1a indicates that, for example, an allergen for the customer 4 is eggs and the acceptable egg intake for the customer 4 is 10 g. The information also indicates that the product 5 is cookies and the amount of eggs per cookie is 5 g. Based on the information, the calculating unit 1b acquires the information about the restriction on intake of the product 5 by calculating as follows: 10 (g)÷5 (g/cookie)=2 (cookies). The allergy information 6 includes, as the information about the restriction on intake of the product 5, information indicating that the allergen is “eggs”; the product is “cookies”; and the adequate intake is “2 cookies”. In the case where the name of the customer 4 is stored in the storing unit 1a in association with the identification information of the customer 4, the calculating unit 1b may also include the name of the customer 4 (for example, “Mr. A”) in the allergy information 6.

The output device 3 acquires the allergy information 6 output from the calculating unit 1b and provides it to the customer 4. The output device 3 prints out the allergy information 6, for example, on a written acknowledgment (also sometimes called the “receipt”) or sales slip issued at the time of purchase of products. The output device 3 may also display the content of the allergy information 6 on its display. The output device 3 may output the content of the allergy information 6 as an audio message, or send it to an e-mail address of the customer 4.

Allergic patients are able to learn the amount of acceptable intake of food allergens for them by taking food challenge tests at medical institutions and have meals adhering to the acceptable intake, thereby improving the quality of their lives. Providing, to customers, information on whether or not each product contains ingredients identified as allergens as information concerning allergies may be considered as one way to prevent health hazards caused by food; in this method, however, customers with allergic conditions have trouble in figuring out how much food containing allergens for them they are allowed to eat. For example, each of such customers needs to read the label on a product to see ingredients and then calculate, based on the contained amount of each ingredient and the net weight of the product, how much of the product he/she is allowed to eat, which takes a lot of effort and time of the customer.

In view of the above-described problem, if the product information about products for purchase by a customer includes a particular product containing an allergen for the customer, the product purchase processor 1 outputs information about the restriction on the product intake based on the ingestion restriction information on the allergen. Herewith, when the product for purchase contains the allergen for the customer, it is possible to raise an appropriate alert on the amount of intake to the customer. The alert is given in simple terms which are easy for consumers to understand (for example, “2 cookies”), which allows the customer to easily understand the amount of the product he/she is allowed to eat while keeping the allergen to be ingested below or equal to the acceptable amount. As a result, the customer casually enjoys their meals with ease. Thus, the first embodiment is able to ease the burden on customers with allergic conditions and contribute to improving the quality of their lives.

Note that the first embodiment illustrates an example of outputting the allergy information 6 for the customer 4; however, allergy information for individuals other than the customer 4 may be output when the customer 4 purchases the product 5. This is directed to the case, for example, where not the customer 4 but some family members of the customer 4 (such as a spouse, children, and parents and ground parents living with the customer 4) may be allergic. The calculating unit 1b may output allergy information for the allergic family members in association with names of the individual members. In order to output the allergy information for the allergic family members of the customer 4, the identification information, names, and allergen ingestion restriction information of each of the family members may be stored in advance in the storing unit 1a in association with the identification information of the customer 4.

### (b) Second Embodiment

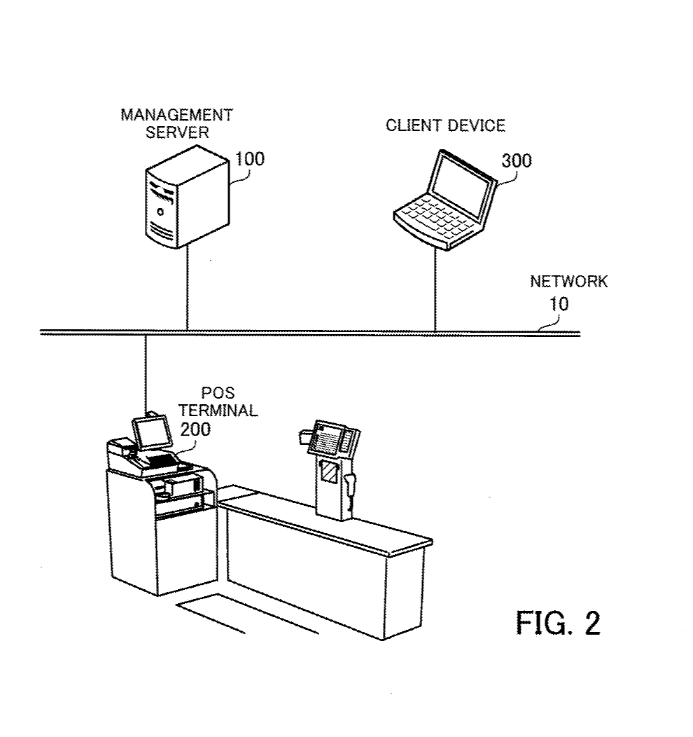

FIG. 2 illustrates an example of a POS system according to a second embodiment. The POS system of the second embodiment is installed at a retail shop selling food as commercial products. The POS system may be said to be an information processing system for managing point-of-sale information. The POS system of the second embodiment includes a management server 100, a POS terminal 200, and a client device 300. The management server 100, the POS terminal 200, and the client device 300 are individually connected to a network 10, which is, for example, a local area network (LAN) installed at the shop. The management server 100 may be installed at a base different from the shop (for example, at a data center). In that case, the management server 100 may be connected to the network 10 via a network at the base and a network connecting the base and the shop.

The management server 100 is a server computer for managing information on products and customers. The management server 100 provides the information on products and customers to the POS terminal 200. The POS terminal 200 is a client computer operated by a shop assistant. The POS terminal 200 receives entries of identification information of each customer and identification information of each product for purchase by the customer. The POS terminal 200 also handles checkout reconciliation of the entered products and issues a receipt for the purchased products. The POS system of the second embodiment may be provided with a plurality of POS terminals. The client device 300 is a client computer used to register new information in the management server 100 and update information already registered in the management server 100.

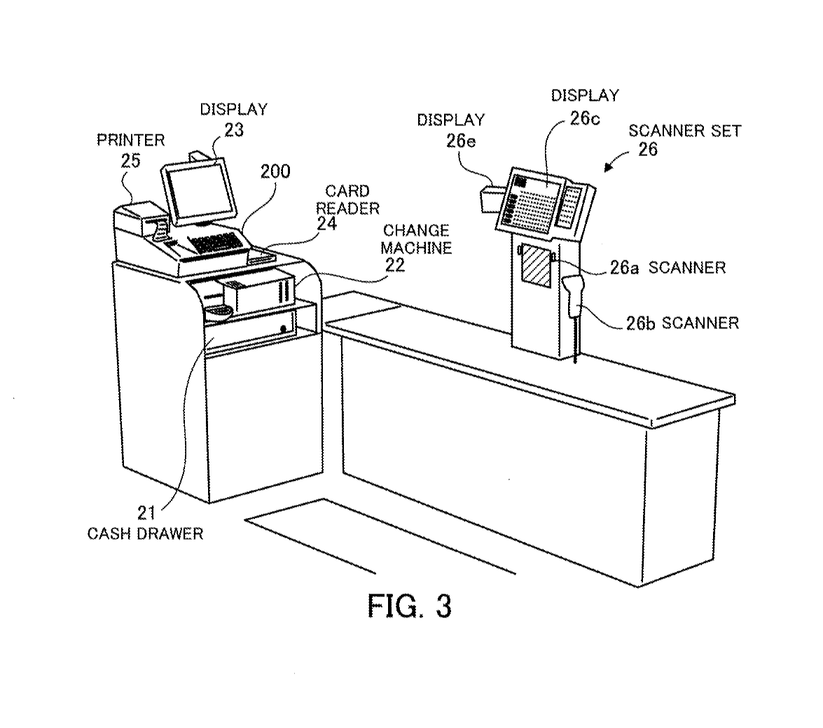

FIG. 3 illustrates an example of peripherals of the POS terminal according to the second embodiment. To the POS terminal 200, a cash drawer 21, a change machine 22, a display 23, a card reader 24, a printer 25, and a scanner set 26 are connected. The cash drawer 21 holds coins and currency. The change machine 22 performs money reception and payment processing (input and output of coins and currency) associated with checkout reconciliation of purchased products. The display 23 displays a graphical user interface (GUI) provided to a shop assistant according to screen information output from the POS terminal 200. The GUI displayed on the display 23 includes, for example, products already entered using the scanner set 26, a list of prices, and the current merchandise total. The display 23 is provided with a touch panel for receiving a touch operation on the GUI.

The card reader 24 reads information on an IC card owned by each customer and outputs the information to the POS terminal 200. The printer 25 issues a receipt by printing output from the POS terminal 200 on receipt paper. The following items, for example, are printed on the receipt: the time and date of the purchase; the purchase shop; a list of names of the purchased products; the price of each of the products; the total sum; the amount tendered; and the change. As described later, in the case where a customer and/or family members of the customer are patients with allergic conditions, allergy information for the customer and/or the family members is printed on the receipt.

The scanner set 26 includes a plurality of input devices used to enter identification information of each product. The scanner set 26 includes scanners 26a and 26b and displays 26c and 26e. The scanner 26a is a camera scanner for reading a barcode label on a product to acquire identification information of the product. The scanner 26b is a reel line-sensor scanner for reading a barcode label on a product to acquire identification information of the product. The display 26c displays a GUI for a shop assistant to allow him/her to enter identification information of each product. The display 26c includes a touch panel for receiving a touch operation on the GUI. The display 26e displays a GUI for providing a customer with information on each product and receiving an operation input made by the customer. The display 26e includes a touch panel for receiving a touch operation on the GUI. Note that the touch panel on each of the card reader 24, the scanners 26a and 26b, the displays 23, 26c, and 26e is one example of the input device 2 of the first embodiment. The printer 25 and the display 26e are examples of the output device 3 of the first embodiment.

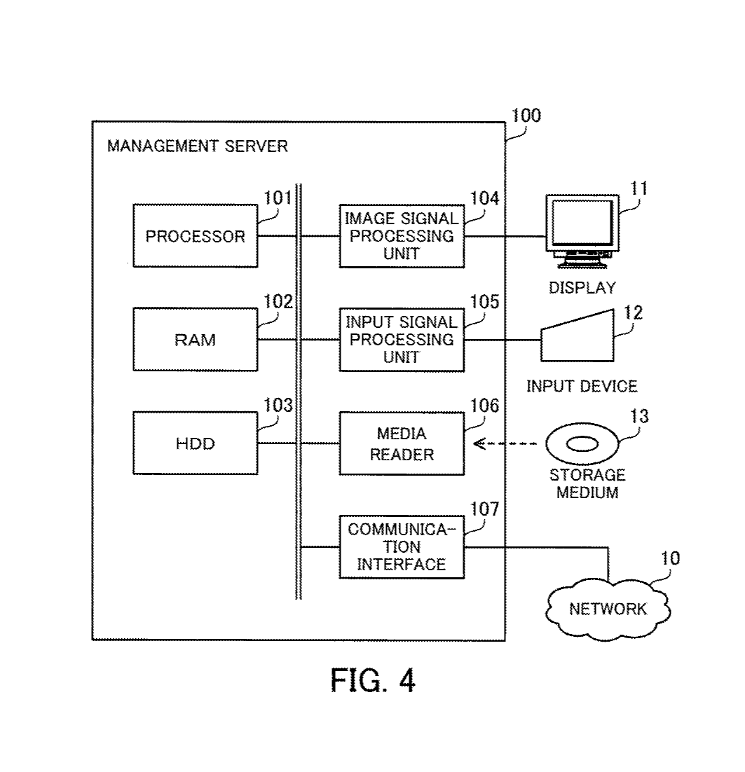

FIG. 4 illustrates an example of hardware of the management server according to the second embodiment. The management server 100 includes a processor 101, RAM 102, a HDD 103, an image signal processing unit 104, an input signal processing unit 105, a media reader 106, and a communication interface 107. These individual units are connected to a bus of the management server 100. The client device 300 may be implemented using the same hardware components as the management server 100. The processor 101 controls information processing of the management server 100. The processor 101 may be a multi-processor. The processor 101 is, for example, a CPU, a DSP, an ASIC, a FPGA, or a combination of two or more of these.

The RAM 102 is used as the main storage device of the management server 100. The RAM 102 temporarily stores at least part of an operating system (OS) program and application programs to be executed by the processor 101. The RAM 102 also stores therein various types of data to be used by the processor 101 for its processing. The HDD 103 is a secondary storage device of the management server 100, and magnetically writes and reads data to and from a built-in magnetic disk. The HDD 103 stores therein the OS program, application programs, and various types of data. Instead of the HDD 103, the management server 100 may be provided with a different type of secondary storage device such as flash memory or a solid state drive (SSD), or may be provided with a plurality of secondary storage devices. The image signal processing unit 104 outputs an image to a display 11 connected to the management server 100 according to an instruction from the processor 101. A cathode ray tube (CRT) display or a liquid crystal display, for example, may be used as the display 11.

The input signal processing unit 105 acquires an input signal from an input device 12 connected to the management server 100, and outputs the signal to the processor 101. A pointing device, such as a mouse or a touch panel, or a keyboard may be used as the input device 12. The media reader 106 is a device for reading programs and data recorded on a storage medium 13. Examples of the storage medium 13 include a magnetic disk such as a flexible disk (FD) and a HDD, an optical disk such as a compact disc (CD) and a digital versatile disc (DVD), and a magneto-optical disk (MO). Alternatively, a non-volatile semiconductor memory, such as a flash memory card, may be used as the storage medium 13. The media reader 106 stores, for example, programs and data read from the storage medium 13 in the RAM 102 or the HDD 103 according to an instruction from the processor 101. The communication interface 107 communicates with the POS terminal 200 and the client device 300 via the network 10. The communication interface 107 may be either a wired or wireless communication interface.

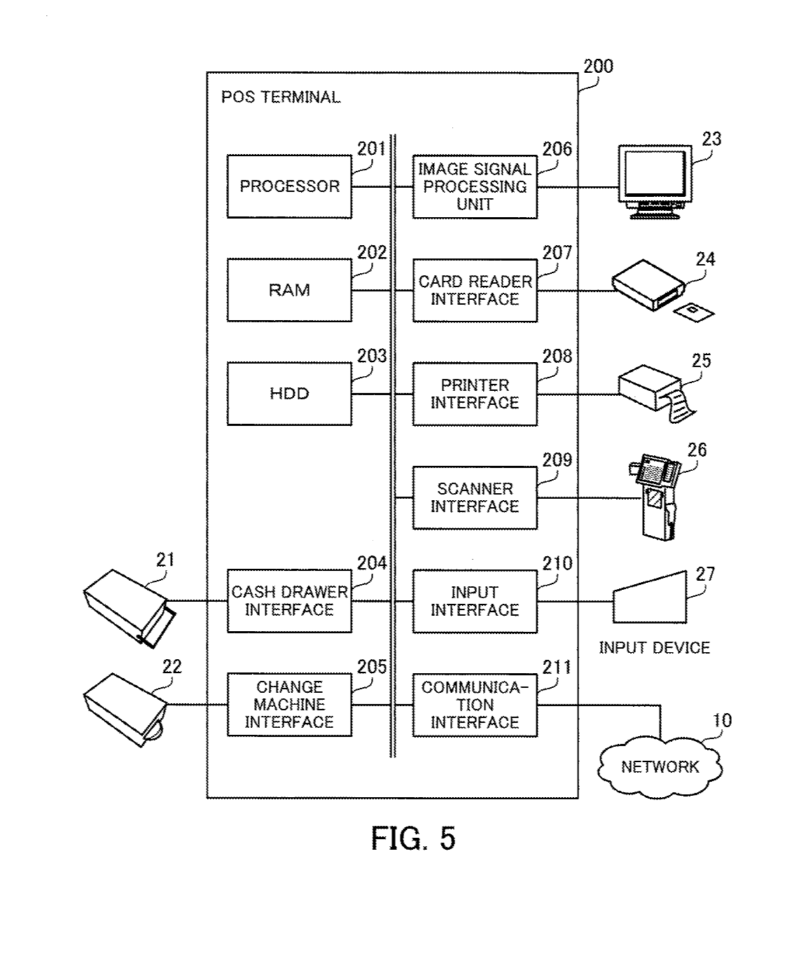

FIG. 5 illustrates an example of hardware of the POS terminal according to the second embodiment. The POS terminal 200 includes a processor 201, RAM 202, a HDD 203, a cash drawer interface 204, a change machine interface 205, an image signal processing unit 206, a card reader interface 207, a printer interface 208, a scanner interface 209, an input interface 210, and a communication interface 211. The processor 201 controls information processing of the POS terminal 200. The processor 201 may be a multi-processor. The processor 201 is, for example, a CPU, a DSP, an ASIC, a FPGA, or a combination of two or more of these. The RAM 202 is used as the main storage device of the POS terminal 200. The RAM 202 temporarily stores at least part of an OS program and application programs to be executed by the processor 201. The RAM 202 also stores therein various types of data to be used by the processor 201 for its processing.

The HDD 203 is a secondary storage device of the POS terminal 200, and magnetically writes and reads data to and from a built-in magnetic disk. The HDD 203 stores therein the OS program, application programs, and various types of data. Instead of the HDD 103, the POS terminal 200 may be provided with a different type of secondary storage device such as flash memory or a SSD, or may be provided with a plurality of secondary storage devices. The cash drawer interface 204 communicates with the cash drawer 21 according to an instruction from the processor 201. Via the cash drawer interface 204, the processor 201 is able to open and close storage for coins and currency of the cash drawer 21. The change machine interface 205 communicates with the change machine 22 according to an instruction from the processor 201. Via the change machine interface 205, the processor 201 is able to cause the change machine 22 to perform money reception and payment processing.

The image signal processing unit 206 outputs images to displays 23, 26c, and 26e according to instructions from the processor 201 (the displays 26c and 26e are not illustrated in FIG. 5). Liquid crystal displays, for example, may be used as the displays 23, 26c, and 26e. The card reader interface 207 is connected to the card reader 24, and reads customer information from an IC card owned by a customer and outputs it to the processor 201. The printer interface 208 communicates with the printer 25 according to an instruction from the processor 201. Via the printer interface 208, the processor 201 issues a receipt by outputting the content of the receipt to the printer 25.

The scanner interface 209 acquires information scanned by scanners 26a and 26b on the scanner set 26 and information entered through a touch panel on the scanner set 26, and then outputs the information to the processor 201. The input interface 210 outputs, to the processor 201, information entered by an input device 27 on the POS terminal 200. The input device 27 is, for example, a keyboard, a mouse, or a touch panel. The communication interface 211 communicates with the management server 100 via the network 10. The communication interface 211 may be either a wired or wireless communication interface.

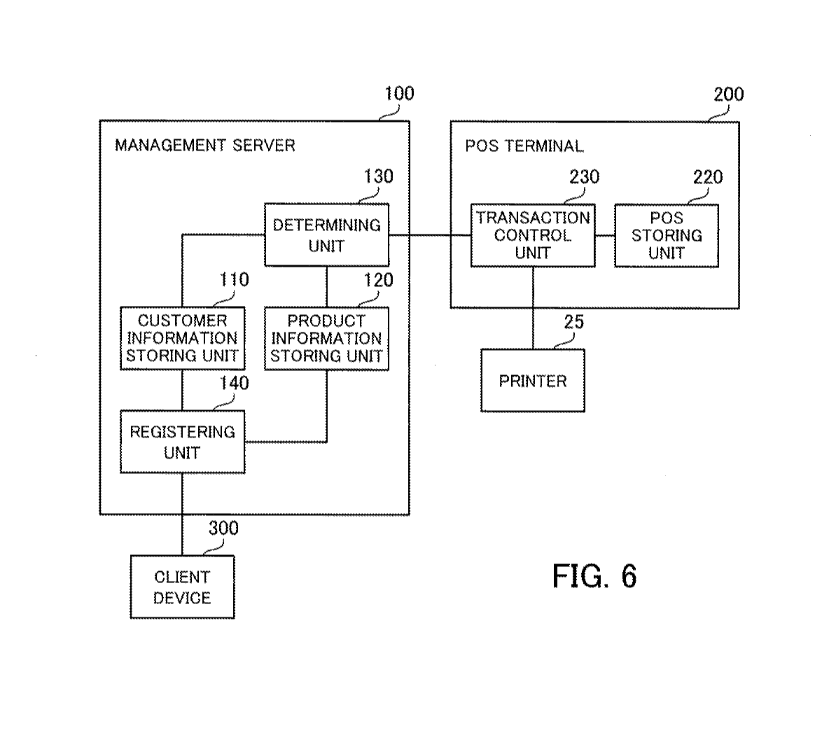

FIG. 6 illustrates an example of functional components according to the second embodiment. The management server 100 includes a customer information storing unit 110, a product information storing unit 120, a determining unit 130, and a registering unit 140. The customer information storing unit 110 is implemented as a storage area secured in the RAM 102 or the HDD 103. The determining unit 130 and the registering unit 140 are implemented by the processor 101 executing a program stored in the RAM 102.

The customer information storing unit 110 stores therein information on customers of the retail shop (hereinafter referred to as the “customer information”). The customer information includes, in addition to basic information such as identification information of the customers (customer identifiers (ID)) and their names, information on family members of each customer, and information concerning allergies that the customer and/or his/her family members have (such as allergens and the amount of acceptable ingestion of each allergen per serving).

The product information storing unit 120 stores therein information on each product sold by the retail shop (referred to as the “product information”). The commercial products include food products. The food products include, for example, fresh food such as eggs, meat, fish, and vegetables; processed food such as snacks, prepared dishes, and box lunches; seasonings; and beverages. The product information includes information on the food products (for example, information on ingredients of each food product and additives added thereto).

The determining unit 130 receives, from the POS terminal 200, identification information of a customer who is purchasing products and identification information of each of the products for purchase by the customer. With reference to the product information storing unit 120, the determining unit 130 acquires product information of each of the products for purchase. With reference to the customer information storing unit 110, the determining unit 130 acquires information concerning allergies that the customer and/or his/her family members have. Based on the acquired product information and information concerning the allergies, the determining unit 130 outputs, to the POS terminal 200, information about a restriction on product intake for the customer and/or his/her family members, associated with a specific product for purchase by the customer (the “allergy information”).

The registering unit 140 registers customer information to be stored in the customer information storing unit 110 and product information to be stored in the product information storing unit 120. For example, the registering unit 140 provides the client device 300 with a GUI for supporting the system administrator to register the customer information and the product information. Specifically, the registering unit 140 may function as a web server and provide a web page corresponding to the GUI to a web browser running on the client device 300. For example, the system administrator inputs on the GUI to thereby register customer information and product information in the customer information storing unit 110 and the product information storing unit 120, respectively. The registering unit 140 may cause the display 11 connected to the management server 100 to display the GUI. In this case, the system administrator uses the input device 12 connected to the management server 100 to register the customer information and the product information. Note that the registering unit 140 may receive a registration of customer information from each customer. For example, one or more client devices for customer use are installed at the retail shop and the registering unit 140 provides each of these client devices with a GUI to allow a customer to register his/her customer information.

The POS terminal 200 includes a POS storing unit 220 and a transaction control unit 230. The POS storing unit 220 is implemented as a storage area secured in the RAM 202 or the HDD 203. The transaction control unit 230 is implemented by the processor 201 executing a program stored in the RAM 202. The POS storing unit 220 stores therein data to be used by the transaction control unit 230 for its processing. For example, the POS storing unit 220 stores therein information entered by shop assistants at the time of purchase of products by individual customers and information provided by the management server 100. The POS storing unit 220 also stores therein a part of the product information (for example, a product master for managing prices of products and the like) held by the management server 100 in order to facilitate high-speed checkout reconciliation of the POS terminal 200.

The transaction control unit 230 controls sales (purchase transaction) of products to a customer. Specifically, when identification information of products for purchase by the customer is entered, for example, by the scanners 26a and 26b, the transaction control unit 230 calculates the total sum of the products based on the information stored in the POS storing unit 220. The transaction control unit 230 also controls operations of the change machine 22 associated with checkout reconciliation. Using the printer 25, the transaction control unit 230 issues a receipt with, for example, a transaction time and date, a list of the purchased products, the total sum of the products, the amount tendered, and the amount of change printed thereon.

The transaction control unit 230 registers, in the POS storing unit 220, journal information including the time and date of each transaction, a list of the purchased products, the total sum of the products, the amount tendered, and the amount of change. The transaction control unit 230 sends the journal information stored in the POS storing unit 220 to a predetermined server computer for managing sales of the retail shop daily, weekly, or the like. The management server 100 may take on the role of the predetermined server computer.

When the identification information of a customer is entered, for example, from the card reader 24 or the input device 27, the transaction control unit 230 sends the identification information of products for purchase by the customer to the management server 100 together with the identification information of the customer in order to acquire allergy information of the customer (and/or his/her family members). Upon receiving the allergy information from the management server 100, the transaction control unit 230 issues a receipt with the allergy information. Note that the transaction control unit 230 periodically acquires a part of the product information (for example, the product master) from the management server 100 and stores it in the POS storing unit 220 (in order to deal with changes in prices of products due to special offers and the like).

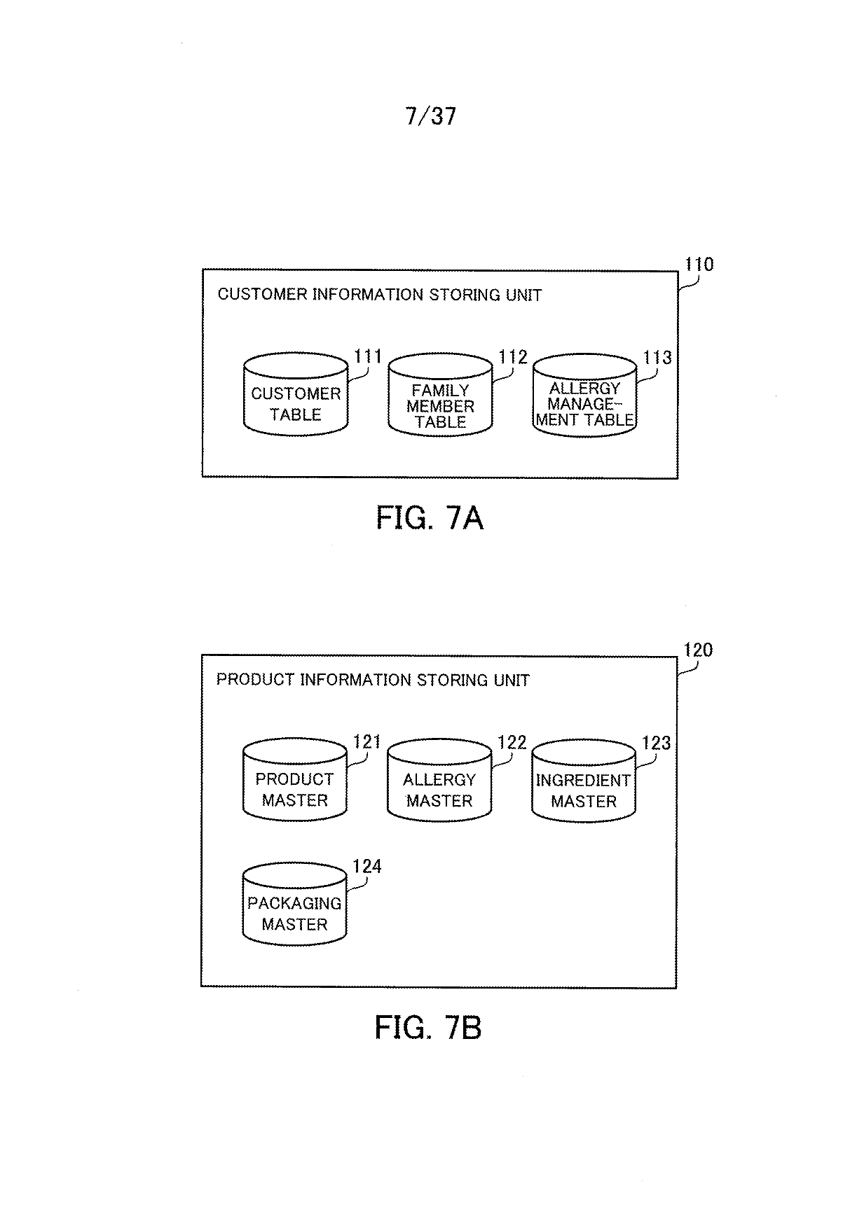

FIGS. 7A and 7B illustrate examples of tables according to the second embodiment. FIG. 7A illustrates an example of tables registered in the customer information storing unit 110. The customer information storing unit 110 includes a customer table 111, a family member table 112, and an allergy management table 113. The customer table 111 manages basic information on customers (such as customer identifiers, names, and addresses). The family member table 112 manages basic information on family members of individual customers (such as family member identifiers and names). The allergy management table 113 manages information on allergies that the customers and/or their family members have.

FIG. 7B illustrates an example of tables registered in the product information storing unit 120. The product information storing unit 120 includes a product master 121, an allergy master 122, an ingredient master 123, and a packaging master 124. The product master 121 manages basic information on products (such as product identifiers and prices). The allergy master 122 manages information on allergens. The ingredient master 123 manages information on ingredients (including additives) contained in each food product. The packaging master 124 manages packaging specifications for each food product.

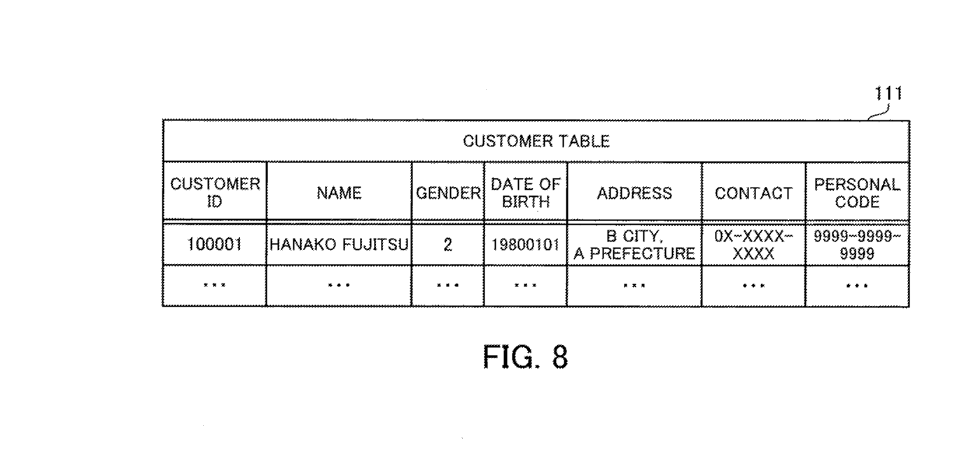

FIG. 8 illustrates an example of the customer table according to the second embodiment. The customer table 111 includes columns of the following items: customer identifier; name; gender; date of birth; address; contact; and personal code. Each field in the customer identifier column contains the customer identifier which is identification information of a customer. Each field in the name column contains the name of the corresponding customer. Each field in the gender column contains the gender of the corresponding customer. For example, numeric values (“1” for male and “2” for female, for example) are used to indicate the gender of each customer. Each field in the date of birth column contains the date of birth of the corresponding customer. Each field in the address column contains the address of the corresponding customer. Each field in the contact column contains the telephone number, the e-mail address, and the like of the corresponding customer. Each field in the personal code column contains the number assigned to the corresponding customer by an organization different from the retail shop. Such personal codes may be social security and tax numbers assigned to customers by their government.

For example, an entry with “100001” in the customer identifier field; “Hanako Fujitsu” in the name field; “2” in the gender field; “19800101” in the date of birth field; “B city, A prefecture” in the address field; “0x-xxxx-xxxx” in the contact field; and “9999-9999-9999” in the personal code field is registered in the customer table 111. This entry indicates that the name of a customer identified by the customer identifier “100001” is “Hanako Fujitsu”; the gender of the customer is female; the date of birth of the customer is Jan. 1, 1980; the address of the customer is “B city, A prefecture”; the customer is reached at the telephone number “0x-xxxx-xxxx”; and the personal code of the customer is “9999-9999-9999”.

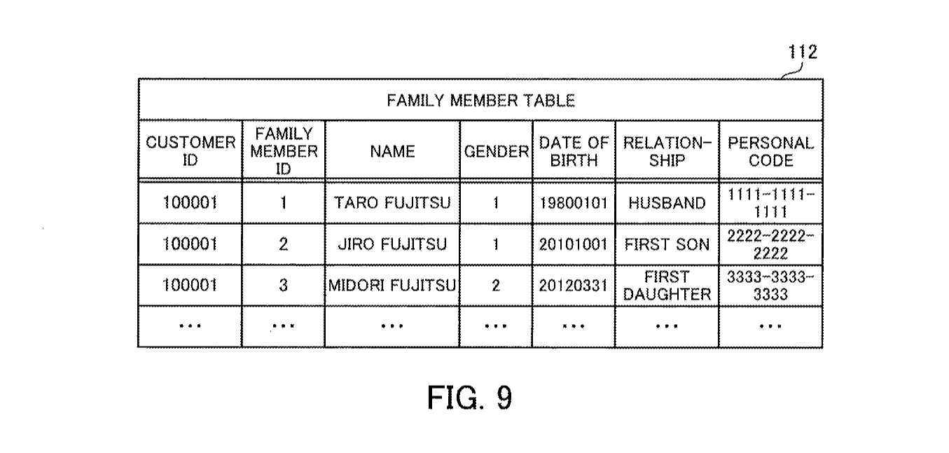

FIG. 9 illustrates an example of the family member table according to the second embodiment. The family member table 112 includes columns of the following items: customer identifier; family member identifier; name; gender; date of birth; relationship; and personal code. Each field in the customer identifier column contains the identifier of a customer. Each field in the family member identifier column contains the family member identifier which is identification information of a family member of the corresponding customer. Each family member of a customer is identified by the pairing of the customer identifier of the customer and the family member identifier of the family member. Each field in the name column contains the name of the corresponding family member. Each field in the gender column contains the gender of the corresponding family member. Each field in the date of birth column contains the date of birth of the corresponding family member. Each field in the relationship column contains the relationship of the corresponding family member to the customer. Each field in the personal code column contains the personal code of the corresponding family member.

For example, an entry with “100001” in the customer identifier field; “1” in the family member identifier field; “Taro Fujitsu” in the name field; “1” in the gender field; “19800101” in the date of birth field; “husband” in the relationship field; and “1111-1111-1111” in the personal code field is registered in the family member table 112. This entry indicates that the name of a family member with the family member identifier “1” of a customer who is identified by the customer identifier “100001” is “Taro Fujitsu”; the gender of the family member is male; the date of birth of the family member is Jan. 1, 1980; the relationship of the family member to the customer is husband; and the personal code of the family member is “1111-1111-1111”.

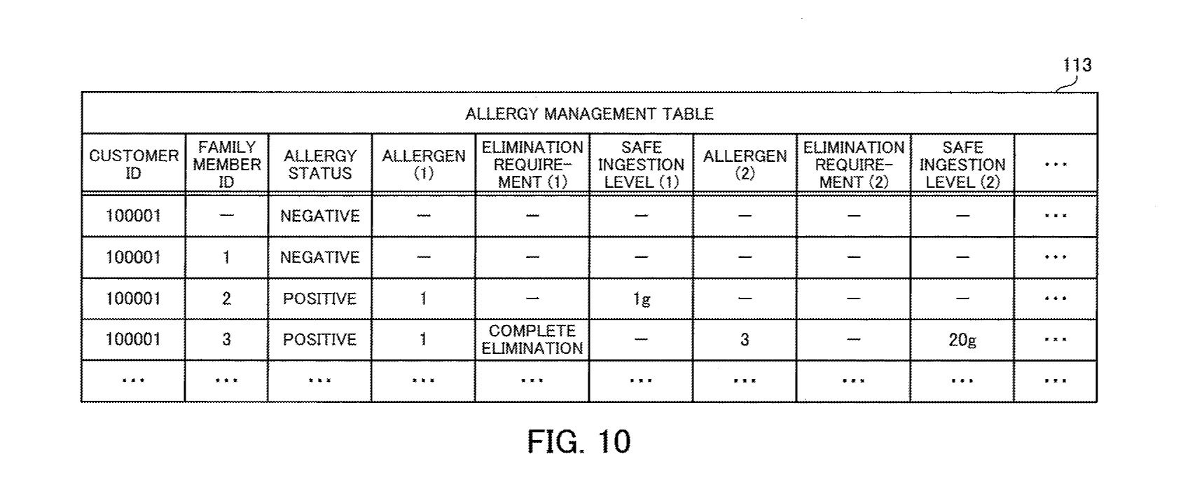

FIG. 10 illustrates an example of the allergy management table according to the second embodiment. The allergy management table 113 includes columns of the following items: customer identifier; family member identifier; allergy status; allergen (1); elimination requirement (1); safe ingestion level (1); allergen (2); elimination requirement (2); and safe ingestion level (2).

Each field in the customer identifier column contains the customer identifier of a customer. Each field in the family member identifier column contains the family member identifier of a family member of the corresponding customer. Each field in the allergy status column contains information indicating whether the corresponding family member has an allergy or not. Each field in the allergen (1) column contains the identification information of an allergen for the corresponding family member (the same applies to each field in the allergen (2) column). Each field in the elimination requirement (1) column contains information indicating if the corresponding family member is not allowed to ingest even a small amount of the corresponding allergen (i.e., complete elimination) (the same applies to each field in the elimination requirement (2) column). In the case where the family member is not allowed to ingest the corresponding allergen at all, the term “complete elimination” is registered in the elimination requirement field. In the case where the corresponding family member is allowed to ingest a certain amount of the corresponding allergen, no information (i.e., negation, which is represented by the symbol “-”) is registered in the elimination requirement field.

Each field in the safe ingestion level (1) column contains the acceptable amount of the corresponding allergen to be ingested (safe ingestion level) per serving (for example, per meal or per snack) when the corresponding allergen is not a complete elimination target (the same applies to each field in the safe ingestion level (2) column). Note here that the safe ingestion level may be the acceptable ingestion amount over a certain period of time, for example, 8, 12, or 24 hours. Customers are able to learn an allergen(s) for them and the acceptable ingestion level of each allergen by taking food challenge tests at medical institutions. Note however that in the case where the allergen is a complete elimination target, no information (“-”) is registered in the corresponding safe ingestion level field. Note that, in FIG. 10, two columns are provided for each of the allergen, elimination requirement, and safe ingestion level items; however, three or more columns may be provided for each (the number of these items may be increased by labeling them as “allergen (3)”, “elimination requirement (3)”, “safe ingestion level (3)” and so on).

For example, an entry with “100001” in the customer identifier field; no information (i.e., negation, which is represented by the symbol “-” in FIG. 10) registered in the family member identifier field; “negative” in the allergy status field; and negation “-” in each of the allergen (1) field, the elimination requirement (1) field, the safe ingestion level (1) field, the allergen (2) field, the elimination requirement (2) field, and the safe ingestion level (2) field is registered in the allergy management table 113. This entry indicates that a customer identified by the customer identifier “100001” has no allergies to food. When the customer does not have food allergies, negation “-” is registered in each of the allergen (1) field, the elimination requirement (1) field, the safe ingestion level (1) field, the allergen (2) field, the elimination requirement (2) field, the safe ingestion level (2) field and the like.

In addition, for example, an entry with “100001” in the customer identifier field; “2” in the family member identifier field; “positive” in the allergy status field; “1” in the allergen (1) field; in the elimination requirement (1) field; “1 g” in the safe ingestion level (1) field; in the allergen (2) field; “-” in the elimination requirement (2) field; and “-” in the safe ingestion level (2) field is registered in the allergy management table 113. This entry indicates that a family member with the family member identifier “2” of a customer identified by the customer identifier “100001” is allergic to food corresponding to the allergen identifier “1”; the food identified by the allergen identifier “1” is not a completion elimination target; and the safe ingestion level is “1 g”.

Further, for example, an entry with “100001” in the customer identifier field; “3” in the family member identifier field; “positive” in the allergy status field; “1” in the allergen (1) field; “complete elimination” in the elimination requirement (1) field; in the safe ingestion level (1) field; “3” in the allergen (2) field; “-” in the elimination requirement (2) field; and “20 g” in the safe ingestion level (2) field is registered in the allergy management table 113. This entry indicates that a family member with the family member identifier “3” of a customer identified by the customer identifier “100001” has allergies. Note here that, as for the entry of the family member with the family member identifier “3”, allergen identifiers are registered in both the allergen (1) and (2) fields. This indicates that the family member is allergic to two food ingredients. Specifically, the entry indicates that the family member is allergic to food corresponding to the first allergen identifier “1”; and the food with the allergen identifier “1” is a complete elimination target. The entry also indicates that the family member is allergic to food corresponding to the second allergen identifier “3”; the food with the allergen identifier “3” is not a complete elimination target; and the safe ingestion level is “20 g”.

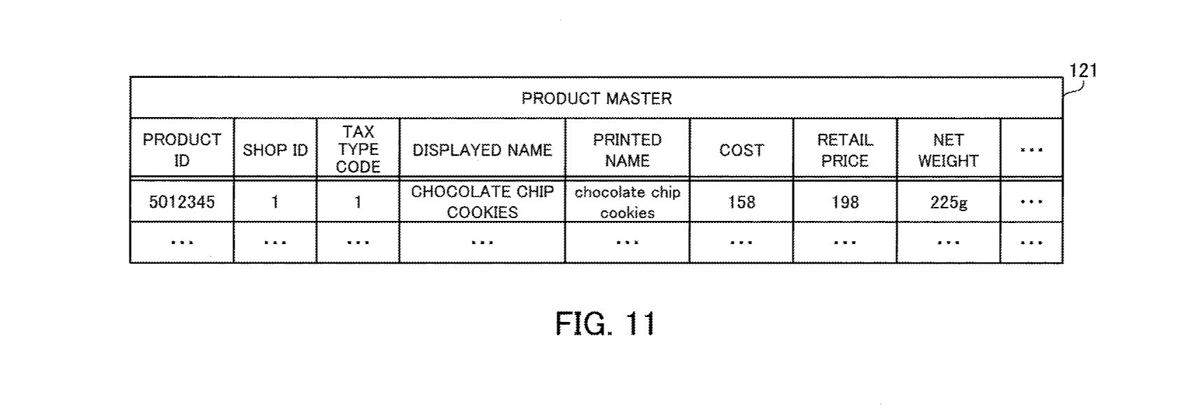

FIG. 11 illustrates an example of the product master according to the second embodiment. The product master 121 includes columns of the following items: product identifier; shop identifier; tax type code; displayed name; printed name; cost; retail price; and net weight. Each field in the product identifier column contains the product identifier which is identification information of a product. Each field in the shop identifier column contains the shop identifier which is identification information of a shop. Each field in the tax type code column contains the code indicating a tax type, such as tax included and tax excluded, in a price list of products (for example, tax type codes “1” and “2” indicate tax included and tax excluded, respectively). Each field in the displayed name column contains the character string indicating a name (displayed name) used when the name of the corresponding product is displayed on a screen. Each field in the printed name column contains the character string indicating a name (printed name) used when the name of the corresponding product is printed on a receipt. Each field in the cost column contains the cost of the corresponding product (in Japanese yen). Each field in the retail price column contains the retail price of the corresponding product (in Japanese yen). Each field in the net weight column contains the net weight of the corresponding product. A variety of items other than those described above may be registered in the product master 121.

For example, an entry with “5012345” in the product identifier field; “1” in the shop identifier field; “1” in the tax type code field; “CHOCOLATE CHIP COOKIES” in uppercase letters in the displayed name field; “chocolate chip cookies” in the printed name field; “158” yen in the cost field; “198” yen in the retail price field; and “225 g” in the net weight field is registered in the product master 121. This entry indicates that, as for a product identified by the product identifier “5012345” at a shop identified by the shop identifier “1”, the tax type is tax included; the displayed name is “CHOCOLATE CHIP COOKIES” in uppercase letters; the printed name is “chocolate chip cookies”; the cost is “158 yen”; the retail price is “198 yen”; and the net weight is “225 g”.

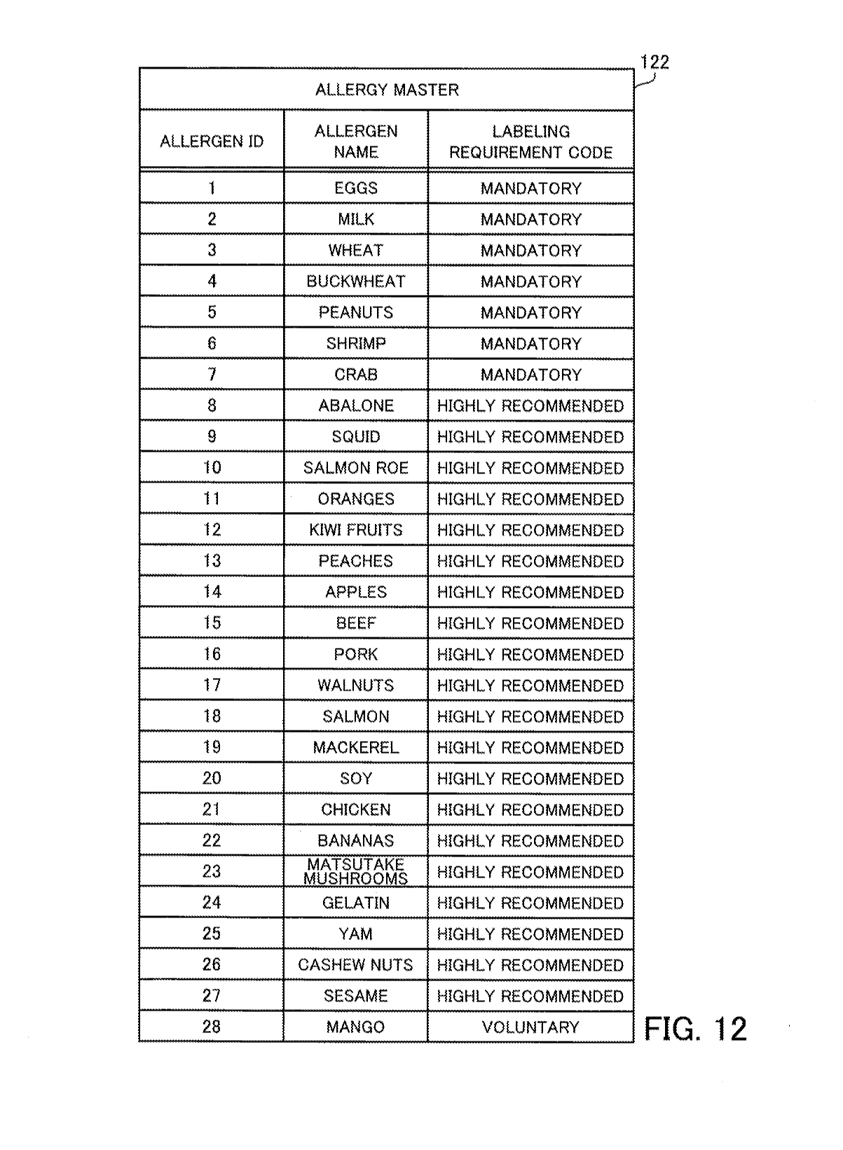

FIG. 12 illustrates an example of the allergy master according to the second embodiment. The allergy master 122 includes columns of the following items: allergen identifier; allergen name; and labeling requirement code. Each field in the allergen identifier column contains the allergen identifier which is identification information of an allergen. Each field in the allergen name column contains the name of the corresponding allergen ingredient. Each field in the labeling requirement code column contains information on legal labeling requirements of the corresponding allergen ingredient. For example, the labeling requirement code for an allergen which has to be labeled is “mandatory”. The labeling requirement code for an allergen the labeling of which is non-mandatory but highly encouraged is “highly recommended”. The labeling requirement code for an allergen the labeling of which is totally voluntary by each retail shop is “voluntary”.

For example, an entry with “1” in the allergen identifier field; “eggs” in the allergen name field; and “mandatory” in the labeling requirement code field is registered in the allergy master 122. This entry indicates that the allergen name of an allergen identified by the allergen identifier “1” is “eggs”; and the labeling of the allergen is “mandatory” (that is, the ingredient needs to be labeled as an allergen). In addition, for example, an entry with “8” in the allergen identifier field; “abalone” in the allergen name field; and “highly recommended” in the labeling requirement code field is registered in the allergy master 122. This entry indicates that the allergen name of an allergen identified by the allergen identifier “8” is “abalone”; and the labeling of the allergen is “highly recommended” (that is, the ingredient need not be, but is highly encouraged to be, labeled as an allergen).

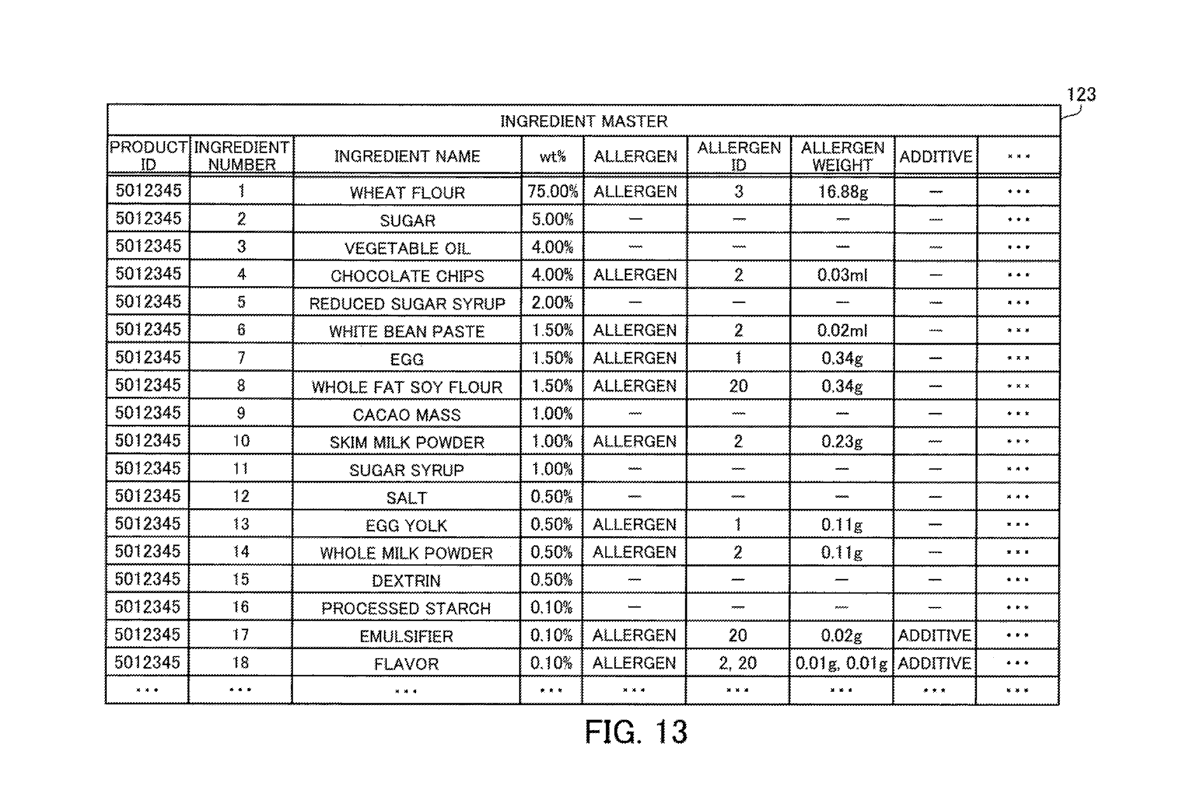

FIG. 13 illustrates an example of the ingredient master according to the second embodiment. The ingredient master 123 includes columns of the following items: product identifier; ingredient number; ingredient name; percentage by weight (wt %); allergen; allergen identifier; allergen weight; and additive. Each field in the product identifier column contains the product identifier of a product. Each field in the ingredient number column contains the ingredient number which is an identification number of an ingredient contained in the corresponding product. Each field in the ingredient name column contains the name of the corresponding ingredient. Each field in the percentage by weight column contains the percentage by weight of the corresponding ingredient per minimum unit amount of the contents of the corresponding product (for example, one cookie if the contents of the product are cookies, and one candy if the contents are candies). Each field in the allergen column contains information indicating whether the corresponding ingredient contains an allergen. Specifically, if the ingredient contains an allergen, the term “allergen” is registered. If the ingredient contains no allergen, negation “-” is registered.

Each field in the allergen identifier column contains the allergen identifier of an allergen in the case where the ingredient contains the allergen. Each field in the allergen weight column contains the weight of a corresponding allergen contained in the ingredient per minimum unit amount of the contents of the corresponding product. Note that if the ingredient does not contain an allergen, negation is registered in each of the allergen identifier and the allergen weight fields. Each field in the additive column contains information indicating whether the corresponding ingredient is an additive. Specifically, the term “additive” is registered if the ingredient is an additive, and negation “-” is registered if the ingredient is not an additive. A variety of items other than those described above may be registered in the ingredient master 123.

For example, an entry with “5012345” in the product identifier field; “1” in the ingredient number field; “wheat flour” in the ingredient name field; “75.00%” in the percentage by weight field; “allergen” in the allergen field; “3” in the allergen identifier field; “16.88 g” in the allergen weight field; and “-” in the additive field is registered in the ingredient master 123. This entry indicates that the ingredient name of an ingredient identified by the ingredient number contained in a product (chocolate chip cookies) with the product identifier “5012345” is “wheat flour”. It also indicates that the percentage by weight of the wheat flour per cookie is 75%. Further, the entry indicates that the wheat flour contains an allergen corresponding to an allergen identifier of “3” (wheat), and the weight of the allergen “wheat” derived from the wheat flour per cookie is “16.88 g”. It also indicates that the wheat flour is not used as an additive.

In addition, an entry with “5012345” in the product identifier field; “2” in the ingredient number field; “sugar” in the ingredient name field; “5.00%” in the percentage by weight field; “-” in the allergen field; “-” in the allergen identifier field; “-” in the allergen weight field; and “-” in the additive field is registered in the ingredient master 123. This entry indicates that the ingredient name of an ingredient identified by the ingredient number “2” contained in a product (chocolate chip cookies) with the product identifier “5012345” is “sugar”. It also indicates that the percentage by weight of the sugar per cookie is 5%. Further, the entry indicates that the sugar contains no allergen and is not used as an additive.

In addition, an entry with “5012345” in the product identifier field; “18” in the ingredient number field; “flavor” in the ingredient name field; “0.10%” in the percentage by weight field; “allergen” in the allergen field; “2, 20” in the allergen identifier field; “0.01 g, 0.01 g” in the allergen weight field; and “additive” in the additive field is registered in the ingredient master 123. This entry indicates that the ingredient name of an ingredient identified by the ingredient number “18” contained in a product (chocolate chip cookies) with the product identifier “5012345” is “flavor”. It also indicates that the percentage by weight of the flavor per cookie is 0.1% and the flavor of the cookie contains two types of allergens corresponding to allergen identifiers of “2” (milk) and “20” (soy), and the weight of the allergen “milk” derived from the flavor per cookie is “0.01 g” and the weight of the allergen “soy” derived from the flavor per cookie is “0.01 g”. Further, the entry indicates that the flavor is used as an additive.

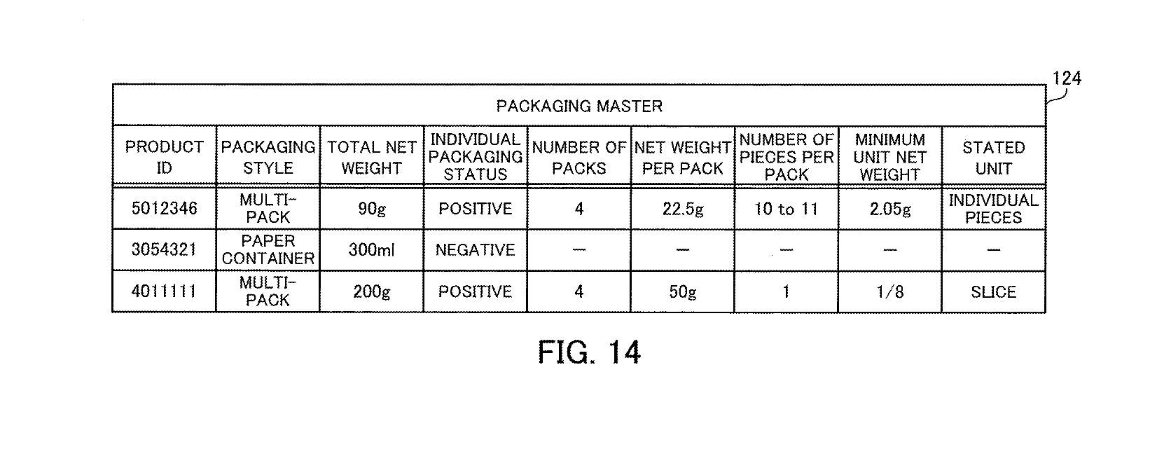

FIG. 14 illustrates an example of the packaging master according to the second embodiment. The packaging master 124 includes columns of the following items: product identifier; packaging style; total net weight; individual packaging status; number of packs; net weight per pack; number of pieces per pack; minimum unit net weight; and stated unit. Each field in the product identifier column contains the product identifier of a product. Each field in the packaging style column contains the style of packaging of the corresponding product. There are various packaging styles including multi-packs, which hold a plurality of smaller individual packages, and paper containers such as paper cartons for beverages. Each field in the total net weight column contains the total net weight of the corresponding product. Each field in the individual packaging status column contains information indicating whether the contents of the product are wrapped into individual packs.

Each field in the number of packs column contains the number of individual packs when the contents of the product are wrapped into the individual packs. Each field in the net weight per pack column contains the net weight of each of the individual packs. Each field in the number of pieces per pack column contains the number of pieces included in each of the individual packs. Each field in the minimum unit net weight column contains the smallest net weight unit (for example, the weight of one cookie or candy). Each field in the stated unit column contains the stated unit used when the adequate intake of the corresponding product for a customer and/or his/her family members is printed on a receipt. Examples of the stated unit are “individual pieces” indicating the number of pieces, e.g. one cookie or two cookies, based on the minimum unit; and “slice” indicating a fraction of the net weight of the corresponding product, e.g. a ⅛ slice or a ¼ slice of one whole pizza.

For example, an entry with “5012346” in the product identifier field; “multi-pack” in the packaging style field; “90 g” in the total net weight field; “positive” in the individual packaging status field; “4” in the number of packs field; “22.5 g” in the net weight per pack field; “10 to 11” in the number of pieces per pack field; “2.05 g” in the minimum unit net weight field; and “individual pieces” in the stated unit field is registered in the packaging master 124. This entry indicates that the packaging style of a product (assuming here that it is cookies) identified by the product identifier “5012346” is a multi-pack (a plurality of inner packages are contained in an outer package); the total net weight is “90 g”; the contents of the product are wrapped into individual packs (i.e. the inner packages); and four individual packs are contained. The entry also indicates that the net weight of each pack is “22.5 g”; the number of cookies contained in each pack is “10” or “11”; the minimum unit net weight (the weight per cookie) is “2.05 g”; and the stated unit is “individual pieces”.

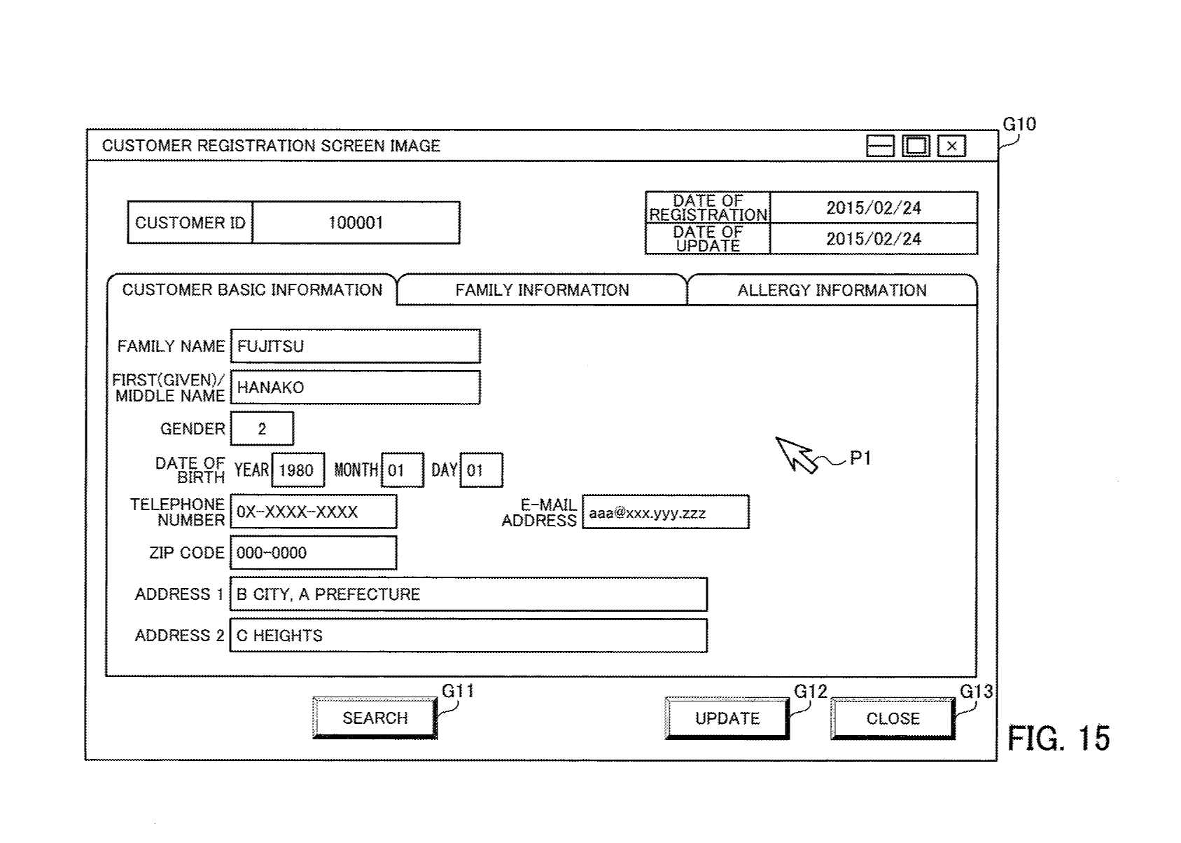

FIG. 15 illustrates a first example of a customer registration screen image according to the second embodiment. A customer registration screen image G10 is a GUI provided for the client device 300 by the registering unit 140. The customer registration screen image G10 is used to register information in the customer table 111. For example, the system administrator selects an entry form of the customer registration screen image G10 by operating a pointer P1 using an input device connected to the client device 300, to thereby register basic information, such as name and gender, of each customer.

The customer registration screen image G10 is provided with buttons G11, G12, and G13. The button G11 is used to display registration information stored in the customer table 111, corresponding to a customer identifier entered on the customer registration screen image G10. When the button G11 is pressed, an instruction for displaying the registration information on the customer registration screen image G10 is sent to the management server 100. The button G12 is used to send, to the management server 100, an instruction for updating registration information displayed on the customer registration screen image G10. The button G13 is used to close the customer registration screen image G10.

The customer registration screen image G10 also includes tabs for “customer basic information”, “family information”, and “allergy information”. Selecting one of the tabs by using the pointer P1 allows for a change in the display of registration information associated with the customer identified by the entered customer identifier. The customer registration screen image G10 is a GUI displayed when the “customer basic information” tab is selected.

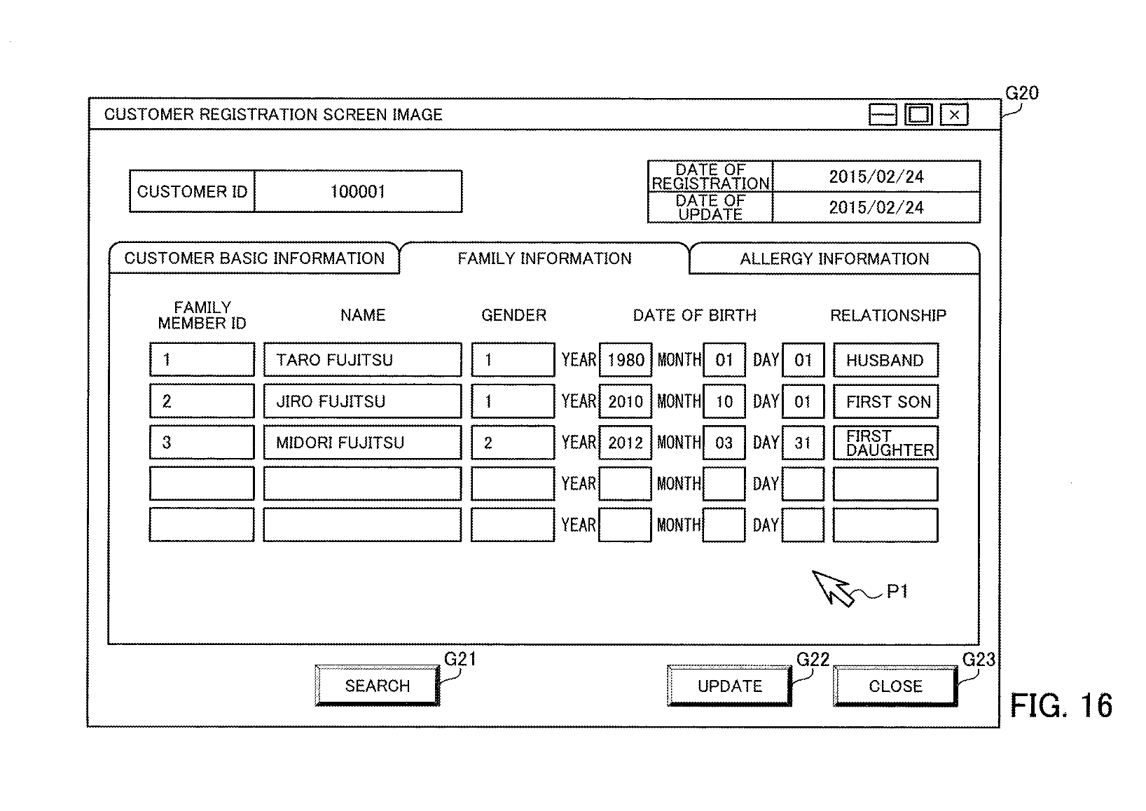

FIG. 16 is a second example of the customer registration screen image according to the second embodiment. A customer registration screen image G20 is a GUI provided for the client device 300 by the management server 100 when the “family information” tab is selected. The customer registration screen image G20 is used to register information in the family member table 112. For example, the system administrator selects an entry form of the customer registration screen image G20 by operating the pointer P1 using the input device connected to the client device 300. Then, the system administrator is able to input information, such as family identifiers and names, of family members of a customer identified by the customer identifier entered on the customer registration screen image G20.

The customer registration screen image G20 is provided with buttons G21, G22, and G23. The button G21 is used to display registration information stored in the family member table 112, corresponding to a customer identifier entered on the customer registration screen image G20. When the button G21 is pressed, an instruction for displaying the registration information on the customer registration screen image G20 is sent to the management server 100. The button G22 is used to send, to the management server 100, an instruction for updating registration information displayed on the customer registration screen image G20. The button G23 is used to close the customer registration screen image G20.

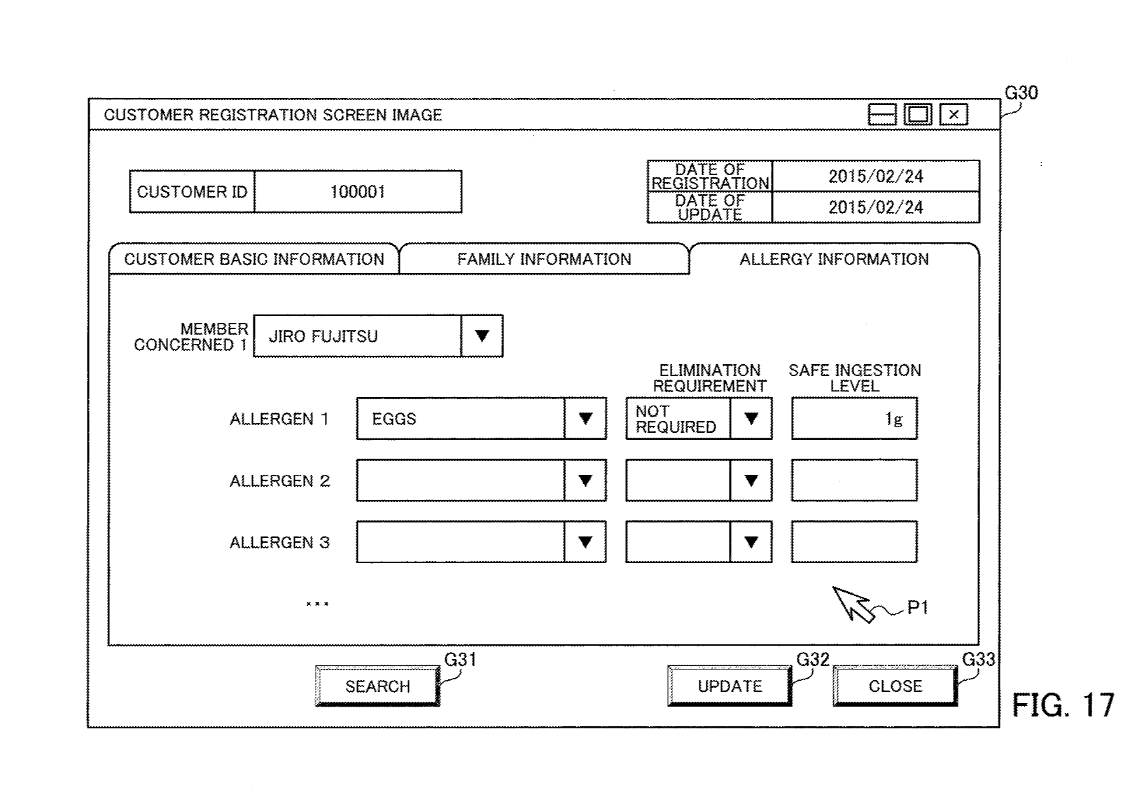

FIG. 17 is a third example of the customer registration screen image according to the second embodiment. A customer registration screen image G30 is a GUI provided for the client device 300 by the management server 100 when the “allergy information” tab is selected. The customer registration screen image G30 is used to register information in the allergy management table 113. For example, the system administrator selects an entry form of the customer registration screen image G30 by operating the pointer P1 using the input device connected to the client device 300. Then, the system administrator is able to input allergy-related information on each family member of a customer identified by the customer identifier entered on the customer registration screen image G30.

The customer registration screen image G30 is provided with buttons G31, G32, and G33. The button G31 is used to display registration information stored in the allergy management table 113, corresponding to a customer identifier entered on the customer registration screen image G30. When the button G31 is pressed, an instruction for displaying the registration information on the customer registration screen image G30 is sent to the management server 100. The button G32 is used to send, to the management server 100, an instruction for updating registration information displayed on the customer registration screen image G30. The button G33 is used to close the customer registration screen image G30.

Note that the information about the customer and his/her family members is entered mainly by the system administrator according to FIGS. 15 to 17; however, the customer may be asked to input such information on the customer registration screens G10, G20, and G30 instead.

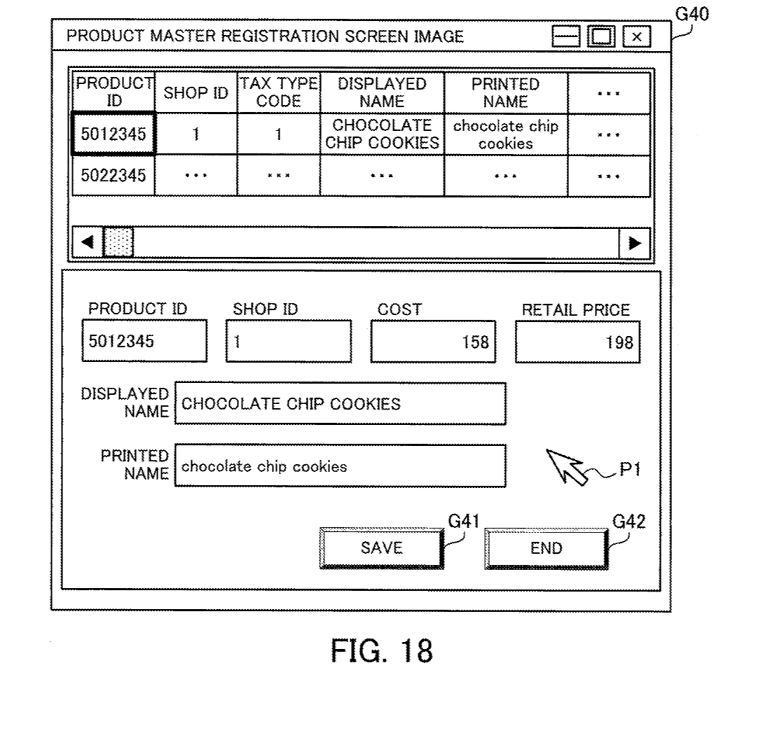

FIG. 18 illustrates an example of a product master registration screen image according to the second embodiment. A product master registration screen image G40 is a GUI provided for the client device 300 by the management server 100. The product master registration screen image G40 is used to register information in the product master 121. For example, the system administrator selects an entry form of the product master registration screen image G40 by operating the pointer P1 using the input device connected to the client device 300. Specifically, a list of registered product identifiers is displayed in the upper part of the product master registration screen image G40. The system administrator is able to select a product identifier from the list using the pointer P1. Registration information on the selected product identifier is displayed in an entry form in the lower part of the product master registration screen image G40. The system administrator selects each item on the entry form by operating the pointer P1, to thereby input registration information. The product master registration screen image G40 is provided with buttons G41 and G42. The button G41 is used to send, to the management server 100, an instruction for incorporating the registration information provided on the entry form. The button G42 is used to close the product master registration screen image G40.

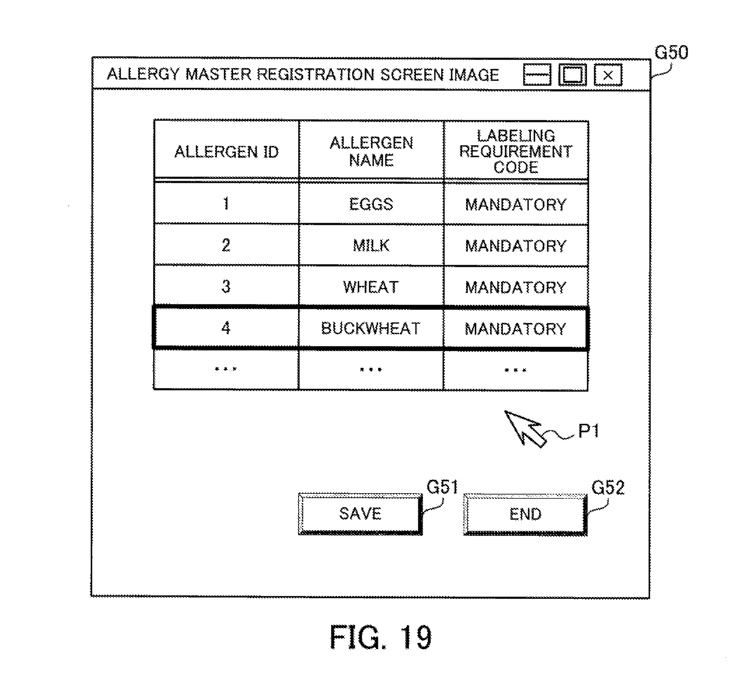

FIG. 19 is an example of an allergy master registration screen image according to the second embodiment. An allergy master registration screen image G50 is a GUI provided for the client device 300 by the management server 100. The allergy master registration screen image G50 is used to register information in the allergy master 122. Specifically, a list of registration information of the allergy master 122 is displayed on the allergy master registration screen image G50. For example, the system administrator is able to select a record from the list using the pointer P1 and change information registered for the allergen identifier, allergen name, and labeling requirement code of the selected record. The allergy master registration screen image G50 is provided with buttons G51 and G52. The button G51 is used to send, to the management server 100, an instruction for incorporating the information entered on the allergy master registration screen image G50 into the allergy master 122. The button G52 is used to close the allergy master registration screen image G50.

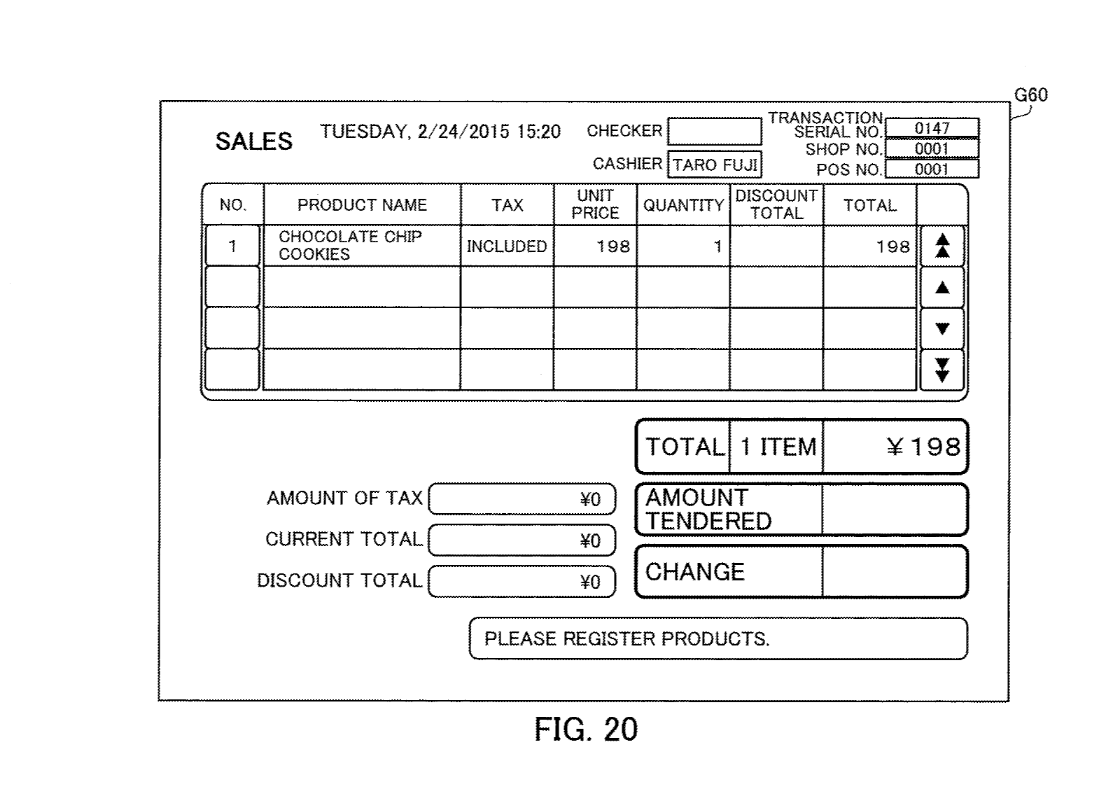

FIG. 20 is an example of a product registration screen image according to the second embodiment. A product registration screen image G60 is a GUI displayed on the display 23 of the POS terminal 200. For example, a list of products entered using the scanner set 26 and the input device 27 is displayed on the product registration screen image G60. A shop assistant operating the POS terminal 200 is able to check the current entry situation of products by referring to the product registration screen image G60.

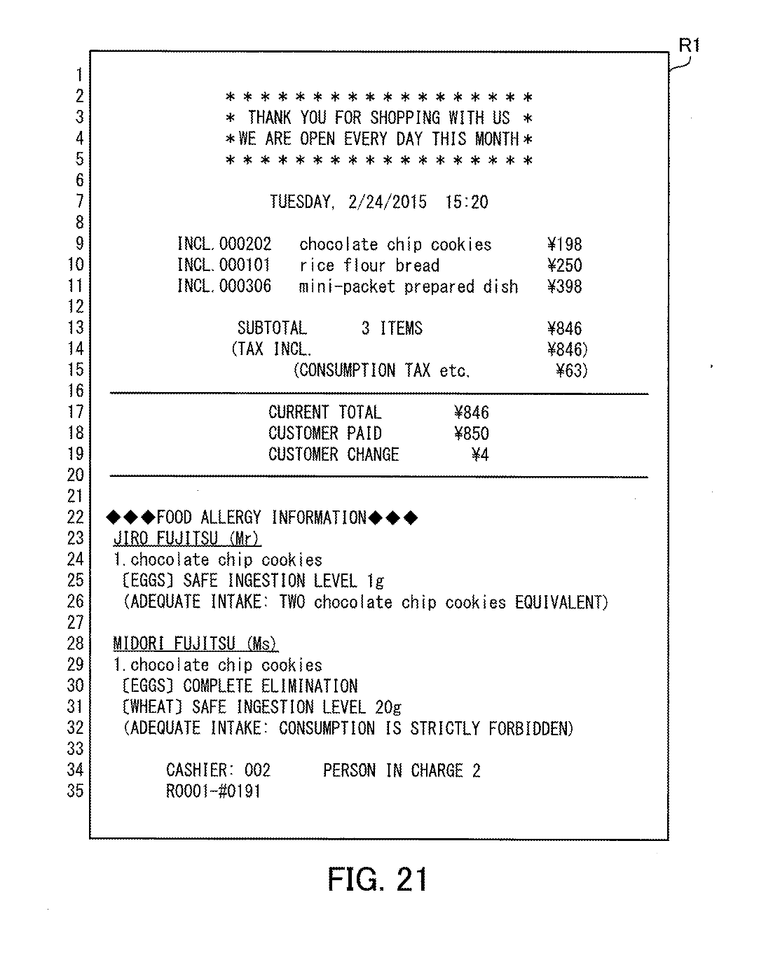

FIG. 21 illustrates a print sample of a receipt according to the second embodiment. A receipt R1 is issued by the POS terminal 200 using the printer 25. The receipt R1 includes character strings representing, for example, a list of products purchased by a customer and their prices, and the amount of money received from the customer and the change on checkout (in lines 1 to 20 on the receipt R1). The receipt R1 also includes, in the case where the customer and/or his/her family members have food allergies, character strings representing allergy information for each of the individuals with allergies (in lines 21 to 32 on the receipt R1). In the remaining lines (i.e., lines 33 to 35) on the receipt R1, character strings representing, for example, identification information of a shop assistant who was in charge of scanning the products on checkout are printed.

Note that the following information items are printed on the receipt R1 as the allergy information (the information items are printed in lines following, for example, a heading saying “FOOD ALLERGY INFORMATION” as it appears in line 22 of the receipt R1, or “FOOD PRODUCT ALLERGY INFORMATION”. The first information item is the name of a person to whom an alert needs to be sent. This is a character string saying “JIRO FUJITSU (Mr)” in line 23 according to the example of the receipt R1. If there is more than one person to whom an alert needs to be assigned, all names of the individuals are printed and the allergy information of each person is provided following the name of the person.

The second information item is the name of a product containing one or more allergens for the corresponding individual. This is a character string saying “1. chocolate chip cookies” in line 24 according to the example of the receipt R1. The character string to represent the name of each product is registered in advance in the product master 121 described above (specifically, the character string is set in the corresponding field within the printed name column in the product master 121). The number prefixed to the name of the product (in this case, “1.”) indicates what number the product is among products included in the food allergy information for the corresponding individual. In the case where two or more products are included in the food allergy information for the corresponding individual, a number is prefixed to the name of each product accordingly (for example, “2.”, “3.”, and the like).

The third information item is the name of each allergen and the safe ingestion level for the corresponding individual per serving. This is a character string saying “[EGGS] SAFE INGESTION LEVEL 1 g” in line 25 according to the example of the receipt R1. Note however that the allergen may be a complete elimination target for the corresponding individual. In such a case, a character string saying “COMPLETE ELIMINATION” is printed in place of the safe ingestion level. According to the example of the receipt R1, a character string saying “[EGGS] COMPLETE ELIMINATION” in line 30 included in the allergy information for “MIDORI FUJITSU (Ms)” illustrates this case.

The fourth information item is the adequate intake of the product specified for the corresponding individual so as not to ingest more than the safe ingestion level of each allergen. This is a character string saying “(ADEQUATE INTAKE: TWO chocolate chip cookies EQUIVALENT)” in line 26 according to the example of the receipt R1. Note that the character string of “chocolate chip cookies” in line 26 of the receipt R1 is printed in lowercase letters, as in the case of the printed name of the product. Examples of the description of the adequate intake, other than “two cookies” above, are “⅛ slice of pizza” and “1 tablespoon of yogurt”.

In the case where the product contains a complete elimination target allergen for the corresponding individual, a character string saying “CONSUMPTION IS STRICTLY FORBIDDEN” is printed as the adequate intake of the product. When a single product contains a plurality of allergens for the corresponding individual, the character string of “CONSUMPTION IS STRICTLY FORBIDDEN” is printed if at least one of the allergens is a complete elimination target. According to the example of the receipt R1, a character string saying “(ADEQUATE INTAKE: CONSUMPTION IS STRICTLY FORBIDDEN” in line 32 illustrates this case.

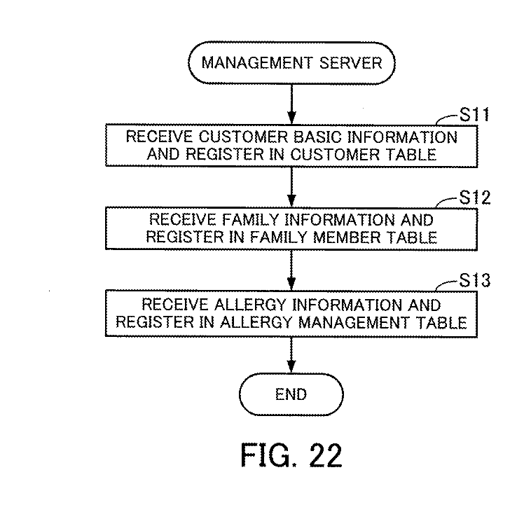

Next described are processing procedures carried out by the management server 100 and the POS terminal 200 according to the second embodiment. First, a customer registration procedure of the management server 100 is described. FIG. 22 is a flowchart illustrating an example of customer registration according to the second embodiment. The process of FIG. 22 is described next according to the step numbers in the flowchart.

(Step S11) The registering unit 140 receives customer basic information (such as the name and gender of a customer) from the client device 300 and registers it in the customer table 111. For example, the registering unit 140 provides the customer registration screen image G10 to the client device 300. The system administrator operates the customer registration screen image G10 using the client device 300 to thereby input the customer basic information to the management server 100.

(Step S12) The registering unit 140 receives family information (such as the name and gender of each family member of the customer) from the client device 300 and registers it in the family member table 112. For example, the registering unit 140 provides the customer registration screen image G20 to the client device 300. The system administrator operates the customer registration screen image G20 using the client device 300 to thereby input the family information to the management server 100.

(Step S13) The registering unit 140 receives allergy information from the client device 300 and registers it in the allergy management table 113. For example, the registering unit 140 provides the customer registration screen image G30 to the client device 300. The system administrator operates the customer registration screen image G30 using the client device 300 to thereby input the allergy information to the management server 100.

Note that, according to the example of FIG. 22, the customer information, the family information, and the allergy information is input mainly by the system administrator; however, not the system administrator, but the customer may be asked to input such information instead.

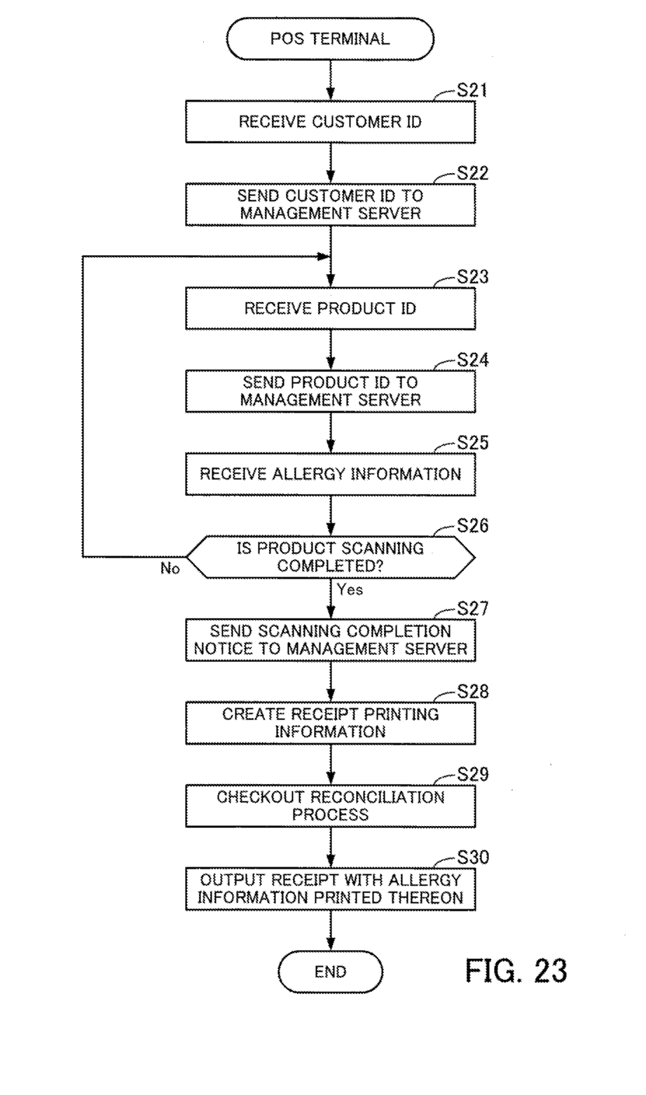

Next described is a checkout processing procedure of the POS terminal 200. FIG. 23 is a flowchart illustrating an example of a POS process according to the second embodiment. The process of FIG. 23 is described next according to the step numbers in the flowchart.

(Step S21) The transaction control unit 230 receives an input of a customer identifier at the start of a checkout process for purchases of products. For example, a shop assistant receives an integrated circuit card owned by a customer from the customer and inserts the card into the card reader 24, which then reads the customer identifier on the integrated circuit card. Subsequently, the transaction control unit 230 receives the customer identifier read by the card reader 24. The transaction control unit 230 may receive the customer identifier through key operations by the shop assistant or communication with a mobile terminal owned by the customer instead.

(Step S22) The transaction control unit 230 sends the received customer identifier to the management server 100.

(Step S23) The transaction control unit 230 receives a product identifier of a product for purchase by the customer. For example, the shop assistant scans a barcode label on the product using the scanner 26a or 26b. The barcode label contains the product identifier, and the scanner 26a or 26b reads the product identifier from the barcode label and outputs it to the POS terminal 200. The transaction control unit 230 subsequently receives the product identifier read by the scanner 26a or 26b. The shop assistant may enter the product identifier into the POS terminal 200 using the touch panel on the display 26c or the input device 27.

(Step S24) The transaction control unit 230 sends the product identifier to the management server 100. Based on a product master stored in the POS storing unit 220 (a copy of the product master 121), the transaction control unit 230 calculates the total sum of currently entered products for purchase and updates the display of the product registration screen image G60.

(Step S25) The transaction control unit 230 receives allergy information from the management server 100.

(Step S26) The transaction control unit 230 determines whether scanning of all products for purchase by the customer is completed. If it is completed, the process moves to step S27. If not, the process moves to step S23. For example, the shop assistant may input scanning completion to the POS terminal 200 using the input device 27. Upon receiving the input, the transaction control unit 230 determines the completion of the product scanning.

(Step S27) The transaction control unit 230 sends a product scanning completion notice to the management server 100.

(Step S28) The transaction control unit 230 creates receipt printing information. The receipt printing information is information of the individual character strings on the receipt R1 illustrated in FIG. 21. Specifically, the receipt printing information includes a list of the products for purchase by the customer and their prices. The receipt printing information also includes allergy information of the customer and/or his/her family members.

(Step S29) The transaction control unit 230 performs a checkout reconciliation process for the customer's purchases. The transaction control unit 230 adds, to the receipt printing information, the amount of money entered into and taken from the change machine 22 by the shop assistant.

(Step S30) Based on the receipt printing information, the transaction control unit 230 outputs the receipt R1 from the printer 25. The allergy information is printed on the receipt R1. In this regard, the transaction control unit 230 may receive, from the management server 100, allergy information indicating that an adequate intake of a particular product for a specific person is “0”. In such a case, the transaction control unit 230 prints a character string saying “CONSUMPTION IS STRICTLY FORBIDDEN” on the receipt R1 as the adequate intake of the product for the person (refer to line 32 on the receipt R1 of FIG. 21). In the case where none of the customer and his/her family members have food allergies, the transaction control unit 230 may receive, in step S25, allergy information indicating no allergies from the management server 100. In the case where none of the customer and his/her family members are allergic to all food ingredients contained in the entire products for purchase by the customer, the transaction control unit 230 outputs a receipt with no allergy information printed thereon from the printer 25.

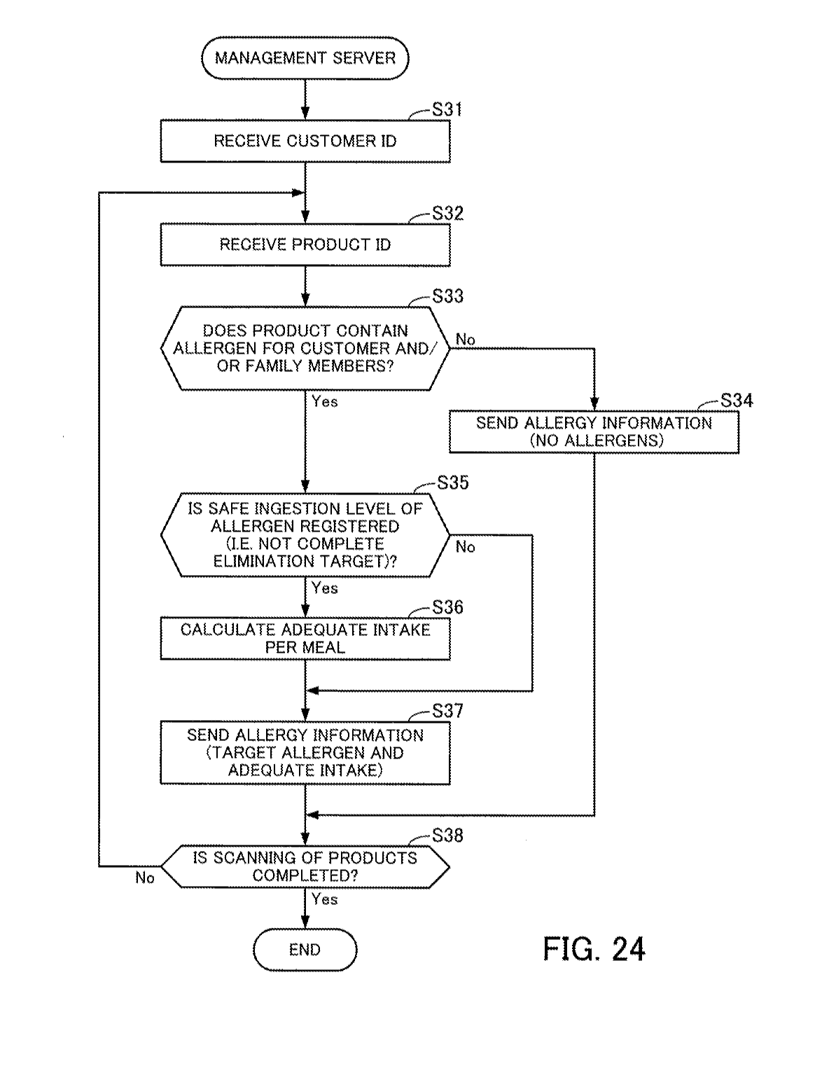

Next described is a processing procedure of the management server 100, carried out in parallel to the POS process of FIG. 23. FIG. 24 is a flowchart illustrating an example of providing allergy information according to the second embodiment. The process of FIG. 24 is described next according to the step numbers in the flowchart.

(Step S31) The determining unit 130 receives the customer identifier from the POS terminal 200. Step S31 corresponds to step S22 of FIG. 23.

(Step S32) The determining unit 130 receives the product identifier from the POS terminal 200. Step S32 corresponds to step S24 of FIG. 23.

(Step S33) The determining unit 130 determines whether a product identified by the product identifier received in step S32 contains an allergen for a customer and/or his/her family members. If the product contains no allergen for the customer and his/her family members, the process moves to step S34. If the product contains an allergen for the customer and/or his/her family members, the process moves to step S35. Specifically, based on the allergy management table 113 and the allergy master 122, the determining unit 130 acquires information on allergens for a customer corresponding to the customer identifier received in step S31 and his/her family members. Further, based on the ingredient master 123, the determining unit 130 determines whether, amongst ingredients corresponding to the product identifier received in step S32, there is an ingredient containing an allergen for the customer and/or his/her family members. Finding such an ingredient indicates that the product identified by the product identifier received in step S32 contains an allergen for the customer and/or his/her family members. On the other hand, if the ingredients corresponding to the product identifier contain no ingredient acting as an allergen for the customer and his/her family members, the product identified by the product identifier received in step S32 contains no allergen for the customer and his/her family members.

(Step S34) The determining unit 130 sends, to the POS terminal 200, allergy information indicating that no allergens are contained in the product corresponding to the product identifier received in step S32. Then, the process moves to step S38.

(Step S35) With reference to the allergy management table 113, the determining unit 130 determines whether the allergen identified in step S33 is not specified as a complete elimination target for a corresponding individual and the safe ingestion level of the allergen for the person has been registered. If the allergen is not specified as a complete elimination target and the safe ingestion level of the allergen has been registered, the process moves to step S36. If the allergen is specified as a complete elimination target, the process moves to step S37.

(Step S36) As for the allergen for the person, the determining unit 130 calculates the adequate intake of the product per meal based on the allergy management table 113 and the ingredient master 123. Assume here that the customer “Hanako Fujitsu” purchases the product “chocolate chip cookies”. According to the allergy management table 113, the allergy master 122, and the ingredient master 123, the product “chocolate chip cookies” contains “eggs” which is an allergen for the family member “Jiro Fujitsu” of the customer “Hanako Fujitsu”. According to the ingredient master 123, each cookie of the product “chocolate chip cookies” contains 0.45 g of “eggs”, which is obtained by 0.34 (g/cookie)+0.11 (g/cookie) (i.e., the sum of the allergen weights corresponding to the ingredient numbers “7” and “13”). According to the allergy management table 113, the safe ingestion level of eggs for “Jiro Fujitsu” is 1 g. The determining unit 130 then calculates the following equation, 1 (g)÷0.45 (g/cookie)=2.22 (cookies), and returns the largest integer not exceeding 2.22, i.e., 2, as the adequate intake of the product for “Jiro Fujitsu”. Note that in the case where the allergen is contained in only one ingredient, the determining unit 130 calculates the adequate intake based on the allergen weight of the single ingredient. If the allergen weight included in the minimum unit amount of the contents of the product exceeds the safe ingestion level of the allergen for the person, the determining unit 130 returns “0” as the adequate intake (indicating that the person must avoid consumption of the product). In the case where a plurality of allergens for the person are contained in the product, the determining unit 130 calculates the adequate intake of the product with respect to each of the allergens and returns the minimum value of the calculated adequate intakes as the adequate intake of the product for the person.

(Step S37) The determining unit 130 sends, to the POS terminal 200, allergy information together with the customer identifier and/or family member identifiers. Note that the determining unit 130 may send allergy information for the customer and one or more of his/her family members. The allergy information includes the allergen of each person concerned and the adequate intake calculated in step S36. The determining unit 130 sends, to the POS terminal 200, “0” as the adequate intake of the product if the answer to step S35 is “NO” or if the allergen weight included in the minimum unit amount of the contents of the product is found, in step S36, to exceed the safe ingestion level of the allergen for the person.

(Step S38) The determining unit 130 determines whether scanning of all products for purchase by the customer is completed. If it is completed, the process ends. If not, the process moves to step S32. Specifically, upon receiving a product scanning completion notice from the POS terminal 200, the determining unit 130 determines the completion of the product scanning.

Note that, in step S33, an allergen may be identified for more than one individual among the customer and his/her family members. In such a case, the determining unit 130 runs steps S35 and S36 for each person allergic to the allergen. Then, the determining unit 130 sends, in step S37, allergy information for each of the individuals to the POS terminal 200. Further, in step S33, a plurality of allergens may be identified for one person. In this case, the determining unit 130 runs steps S35 and S36 for each of the allergens. In step S35, if at least one of the identified allergens is a complete elimination target for the person, the determining unit 130 answers “NO” in step S35 and then moves to step S37. When “0” is indicated as the adequate intake of a product, the POS terminal 200 prints a character string saying “CONSUMPTION IS STRICTLY FORBIDDEN” as the adequate intake of the product on a receipt.

Herewith, when a product for purchase contains the allergen for the customer or his/her family members, an appropriate alert is given on the amount of intake. With the appropriate alert, the customer easily understands the amount of the product he/she is allowed to eat while keeping the allergen to be ingested below or equal to the acceptable amount, and is therefore able to enjoy meals with ease. Thus, the second embodiment is able to ease the burden on customers with allergic conditions and contribute to improving the quality of their lives. Because the allergy information is printed on the receipt R1, the customer is able to refer to the allergy information even after coming home from the shop.

Note that, according to the example illustrated in FIGS. 23 and 24, the POS terminal 200 receives the customer identifier before the start of product scanning; however, the POS terminal 200 may receive the customer identifier after the completion of the product scanning. In this case, the transaction control unit 230 runs steps S21, S22, and S25 of FIG. 23 between steps S27 and S28. In addition, the determining unit 130 stores product identifiers received from the POS terminal 200. Then, upon receiving a product scanning completion notice from the POS terminal 200, the determining unit 130 runs steps S33 to S37 of FIG. 24 for each of the stored product identifiers, and provides the POS terminal 200 with allergy information on each product to be printed on the receipt R1.

Further, in step S36, the determining unit 130 may acquire the adequate intake using information registered in the packaging master 124. For example, in the case where a single product holds a plurality of smaller individual packs, the weight of each allergen ingredient contained per pack may be registered in the ingredient master 123 as the allergen weight of the ingredient. In this case, the determining unit 130 refers to the packaging master 124 to thereby calculate how many minimum units of the contents of the product is allowed to be consumed based on the net weight per pack, the number of pieces per pack, and the minimum unit net weight.

Specifically, let us consider the case where the weight of an allergen ingredient contained per pack is 10 g; the number of pieces per pack is 10 (when the number of pieces per pack ranges, for example, from 10 to 11, the smallest value of the range, 10 in this case, is selected to be on the safe side); and the safe ingestion level of the allergen for a customer is 2 g. In this case, the allergen weight per minimum unit net weight is obtained by the following equation, 10 (g)÷10 (pieces)=1 (g/piece). Then, the determining unit 130 calculates the following equation, 2 (g)÷1 (g/piece)=2 (pieces), and returns 2 pieces as the adequate intake of the product.

Note that the above example mainly illustrates the case where the adequate intake is represented in quantity (the number of pieces) of the contents of a specific product; however, the determining unit 130 may calculate the adequate intake represented in volume, mass, weight, or a percentage of the contents of the product instead.

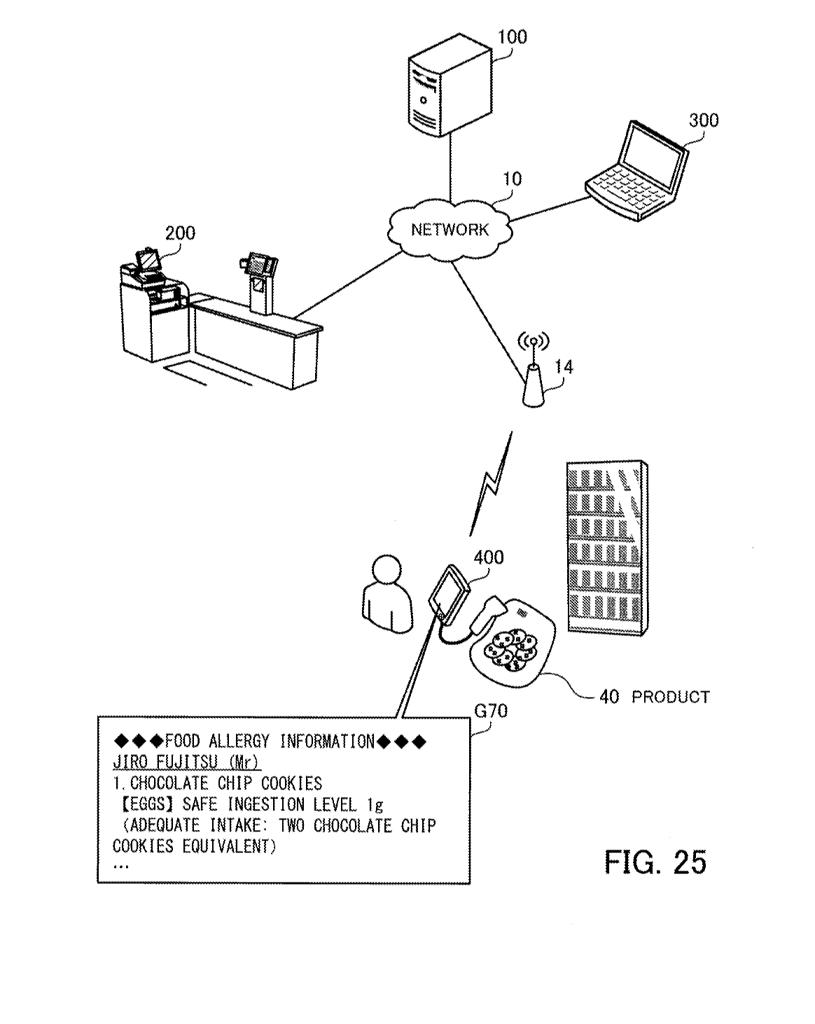

FIG. 25 illustrates another example of providing allergy information according to the second embodiment. According to the foregoing example of the second embodiment, the allergy information of the customer and/or his family members is provided to the customer by printing it on the receipt R1. As another example, a tablet 400 for supporting product selections is lent to a customer, for example, when the customer enters the shop, and allergy information is provided to the customer by displaying it on the tablet 400.

Specifically, the tablet 400 is able to wirelessly communicate with the management server 100 via an access point 14 connected to the network 10. The tablet 400 is provided with a card reader for reading an integrated circuit card owned by a customer and a scanner for reading a barcode label on a product. The customer inputs his/her customer identifier to the tablet 400 by inserting the integrated circuit card into the card reader of the tablet 400. In addition, the customer inputs the product identifier of a product 40 he/she intends to purchase to the tablet 400 by using the scanner to read a barcode label on the product 40.

The tablet 400 reads the customer identifier on the customer's integrated circuit card and sends it to the management server 100. The tablet 400 also reads the product identifier on the barcode label and sends it to the management server 100. In response, the management server 100 runs the procedure illustrated in FIG. 24, to thereby provide the tablet 400 with allergy information for the customer and/or his/her family members in like fashion. For example, the tablet 400 displays, on its screen, a display screen image G70 of the allergy information acquired from the management server 100.

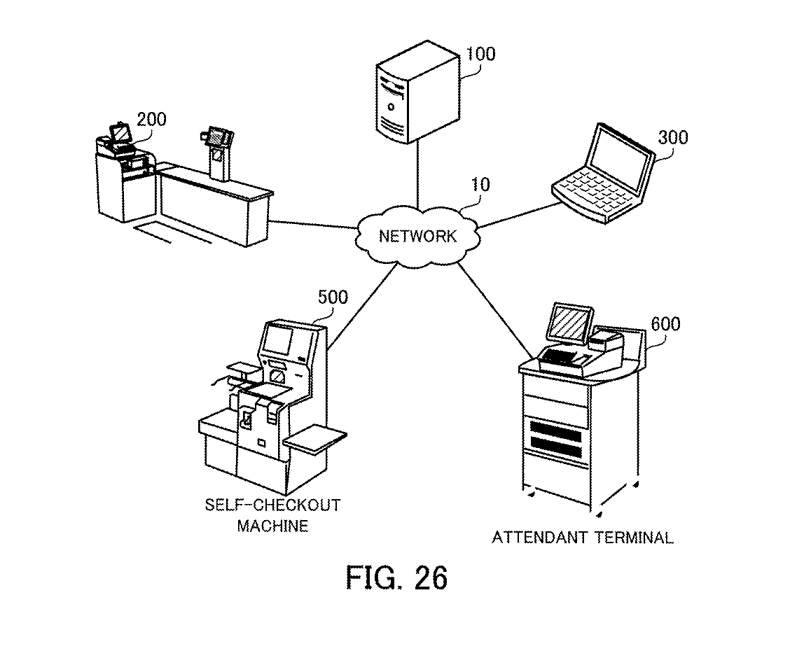

FIG. 26 illustrates a first example of other systems according to the second embodiment. The management server 100 may provide allergy information for a customer also to a different apparatus connected to the network 10 of the shop. For example, a self-checkout machine 500 and an attendant terminal 600 may be connected to the network 10. The self-checkout machine 500 is a terminal unit for supporting customers to input product identifiers of products and pay for their own purchases. The attendant terminal 600 is a terminal unit for a shop assistant to check transactions on the self-checkout machine 500 and assist customers in the processing of their transactions.

For example, the self-checkout machine 500 also acquires allergy information for a customer and/or his/her family members from the management server 100 by sending the customer identifier of the customer and product identifiers to the management server 100. The self-checkout machine 500 is able to print the acquired allergy information on a receipt, as in the case with the POS terminal 200. Alternatively, the allergy information may be provided to the customer through the attendant terminal 600. In this case also, the attendant terminal 600 acquires the allergy information from the management server 100 by sending the customer identifier and the product identifiers to the management server 100. The attendant terminal 600 may output the allergy information by printing it on paper using a printer connected to the attendant terminal 600.

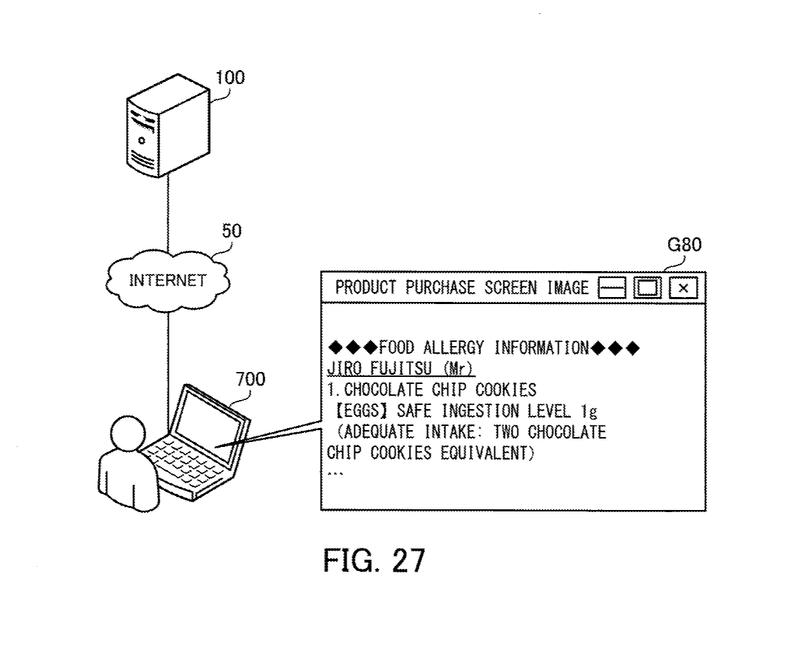

FIG. 27 illustrates a second example of other systems according to the second embodiment. The management server 100 may be connected to the Internet 50. The management server 100 may provide allergy information to the client device 700 connected to the Internet 50. For example, a customer may shop for groceries on an Internet website, such as an online supermarket. In that case, the client device 700 sends, to the management server 100, a customer identifier entered on the client device 700 by the customer (for example, the customer is asked to enter his/her customer identifier on login to the website) and product identifiers of products selected by the customer on the website. Then, based on the customer identifier and product identifiers received from the client device 700, the management server 100 provides the client device 700 with allergy information of the customer and/or his/her family members according to the same procedure illustrated in FIG. 24.

The client device 700 displays the allergy information received from the management server 100 on a product purchase screen image G80. The client device 700 may present the allergy information to the customer when the customer selects a product or when the customer checks out. In addition, the management server 100 may send an e-mail with the allergy information to an e-mail address of the customer.

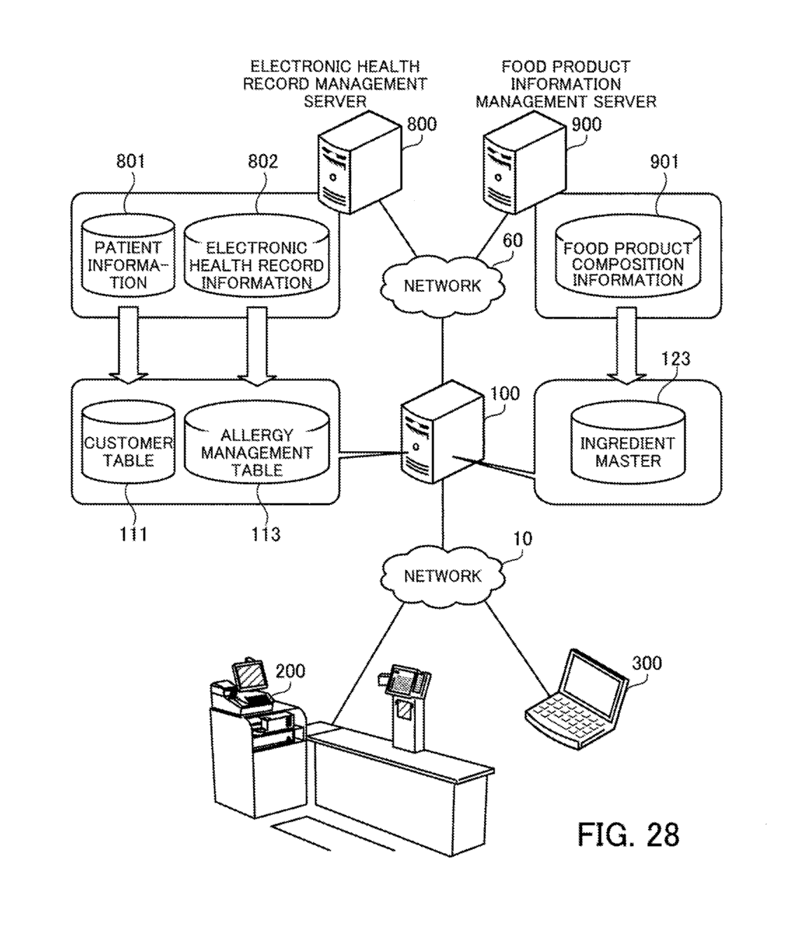

FIG. 28 illustrates a third example of other systems according to the second embodiment. The management server 100 may be connected to an electronic health record management server 800 and a food product information management server 900 via a network 60. The electronic health record management server 800 is a server computer for storing patient information 801 and electronic health record information 802 on patients having visited medical institutions. The patient information 801 includes basic information (such as the name, gender, address, and age) of each patient. In the patient information 801, the basic information of each patient is associated with a personal code, such as a social security and tax number, of the patient. The electronic health record information 802 includes allergy-related information of each patient, including identification information of the patient, allergy status (indicating whether the patient has an allergy or not), allergens, and the safe ingestion level of each allergen per serving. In the electronic health record information 802, the allergy-related information of each patient is associated with a personal code, such as a social security and tax number, of the patient.

The management server 100 may acquire information to be registered in the customer table 111 from the patient information 801. For example, the management server 100 extracts, from the patient information 801, basic information of a customer corresponding to a personal code (for example, a social security and tax number) entered by the customer and registers the basic information in the customer table 111. In addition, the management server 100 may acquire information to be registered in the allergy management table 113 from the electronic health record information 802. For example, based on the personal code of the customer, the management server 100 acquires the basic information of the customer and also acquires, from the electronic health record information 802, allergy-related information associated with the personal code of the customer.

The food product information management server 900 is a server computer for storing food product composition information 901. The food product composition information 901 contains, for example, identification names of individual food products sold as commercial products as well as ingredients and allergens contained in each product and the amount of each allergen contained therein. The management server 100 may acquire information to be registered in the ingredient master 123 from the food product composition information 901. For example, the management server 100 extracts, from the food product composition information 901, information on ingredients corresponding to an identification name of a food product entered by the system administrator, and allergens and the amount of each allergen contained in the food product, and then registers the extracted information in the ingredient master 123.

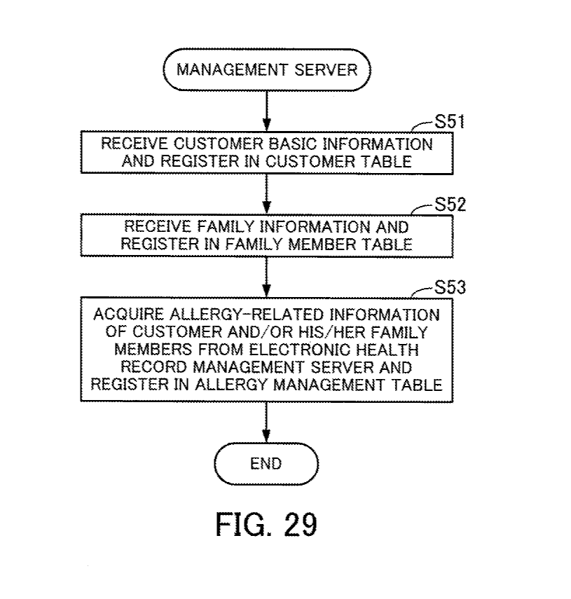

FIG. 29 is a flowchart illustrating another example of the customer registration according to the second embodiment. The process of FIG. 29 is described next according to the step numbers in the flowchart.

(Step S51) The registering unit 140 acquires a personal code of a customer, entered on the client device 300, and requests the electronic health record management server 800 to search the patient information 801 stored in the electronic health record management server 800 using the personal code as a key. The registering unit 140 receives, from the electronic health record management server 800, basic information of the customer obtained from the search, and registers the basic information in the customer table 111.

(Step S52) The registering unit 140 receives family information (such as the name and gender of each family member) of the customer from the client device 300 and registers it in the family member table 112.

(Step S53) The registering unit 140 acquires the personal code of the customer, entered on the client device 300, and requests the electronic health record management server 800 to search the electronic health record information 802 stored in the electronic health record management server 800 using the personal code as a key. The registering unit 140 receives, from the electronic health record management server 800, allergy-related information of the customer and/or his/her family members obtained from the search, and registers the allergy-related information in the allergy management table 113.

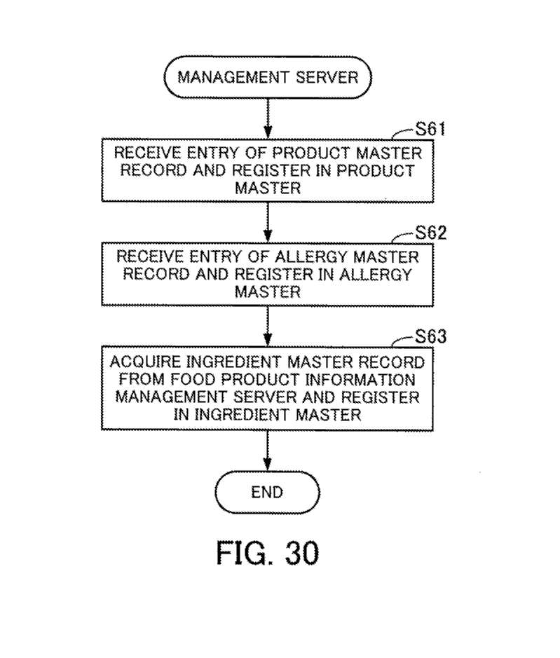

FIG. 30 is a flowchart illustrating an example of product registration according to the second embodiment. The process of FIG. 30 is described next according to the step numbers in the flowchart.

(Step S61) The registering unit 140 receives information to be registered in the product master 121 (referred to as the “product master record”) from the client device 300 and then registers the product master record in the product master 121. For example, the registering unit 140 provides the client device 300 with the product master registration screen image G40. The system administrator operates the product master registration screen image G40 on the client device 300 to thereby enter the product master record into the management server 100.

(Step S62) The registering unit 140 receives information to be registered in the allergy master 122 (the “allergy master record”) from the client device 300 and then registers the allergy master record in the allergy master 122. For example, the registering unit 140 provides the client device 300 with the allergy master registration screen image G50. The system administrator operates the allergy master registration screen image G50 on the client device 300 to thereby enter the allergy master record into the management server 100.

(Step S63) The registering unit 140 acquires an identification name of a food product entered on the client device 300, and requests the food product information management server 900 to search the food product composition information 901 stored in the food product information management server 900 using the identification name as a key. The registering unit 140 receives, from the food product information management server 900, a result of the search (the “ingredient master record”) which includes ingredients and allergens contained in the food product and the amount of each allergen contained therein, and then registers the ingredient master record in the ingredient master 123.

Thus, causing the management server 100 to cooperate with the electronic health record management server 800 facilitates registration of information on customers in the management server 100. In addition, causing the management server 100 to cooperate with the food product information management server 900 facilitates registration of information on ingredients of each food product and allergens contained in the ingredients in the management server 100.

### (c) Third Embodiment

A third embodiment is described next. While omitting repeated explanations, the following description focuses on differences from the second embodiment above. According to the second embodiment, allergy information is provided by the management server 100 to the POS terminal 200; however, the allergy information may be acquired on the POS terminal side. In view of this, the third embodiment is directed to providing a function for the POS terminal to acquire customer's allergy information. According to the third embodiment, a management server 100a is used in place of the management server 100 of the second embodiment. In addition, a POS terminal 200a is used in place of the POS terminal 200 of the second embodiment. The management server 100a and the POS terminal 200a are connected to the network 10. The management server 100a may be constructed with the same hardware configuration as the management server 100. The POS terminal 200a may be constructed with the same hardware configuration as the POS terminal 200. Peripherals similar to those connected to the POS terminal 200 are connected to the POS terminal 200a.

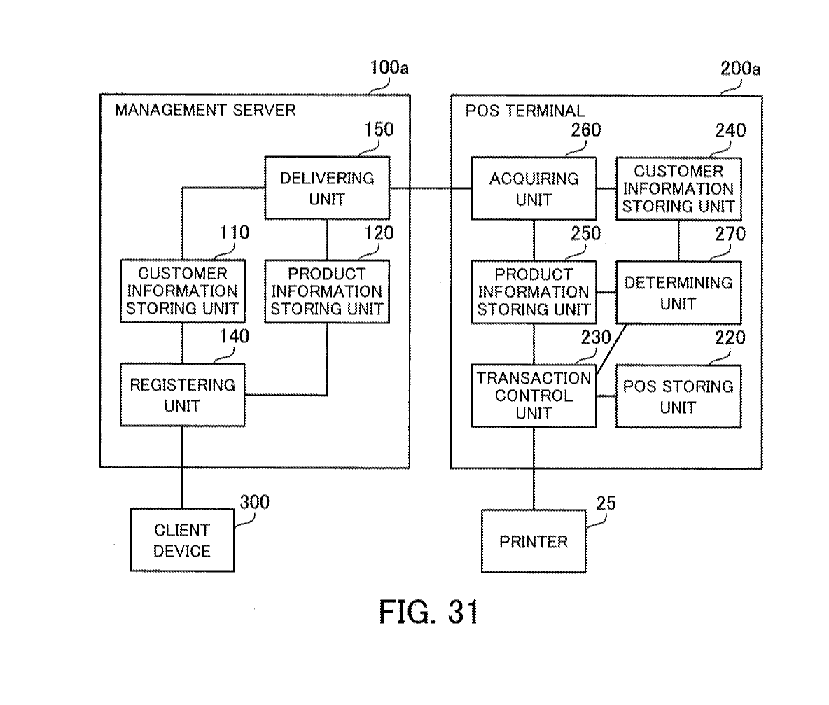

FIG. 31 illustrates an example of functional components according to the third embodiment. The management server 100a includes the customer information storing unit 110, the product information storing unit 120, the registering unit 140, and a delivering unit 150. The management server 100a differs from the management server 100 in having the delivering unit 150 in place of the determining unit 130. The delivering unit 150 is implemented by a processor of the management server 100a running a program stored in RAM of the management server 100a. The delivering unit 150 delivers information stored in the customer information storing unit 110 and the product information storing unit 120 to the POS terminal 200a. For example, the delivering unit 150 may deliver the information with a predetermined period of time. Alternatively, each time information stored in the customer information storing unit 110 and the product information storing unit 120 is updated, the delivering unit 150 may deliver the updated information.

The POS terminal 200a includes the POS storing unit 220, the transaction control unit 230, a customer information storing unit 240, a product information storing unit 250, an acquiring unit 260, and a determining unit 270. The POS terminal 200a differs from the POS terminal 200 in having the customer information storing unit 240, the product information storing unit 250, the acquiring unit 260, and the determining unit 270. Each of the customer information storing unit 240 and the product information storing unit 250 is implemented as a storage area allocated in RAM or a HDD of the POS terminal 200a. The acquiring unit 260 and the determining unit 270 are implemented by a processor of the POS terminal 200a running a program stored in the RAM of the POS terminal 200a.

The customer information storing unit 240 stores therein the same information as the customer information storing unit 110. The product information storing unit 250 stores therein the same information as the product information storing unit 120. The acquiring unit 260 receives information delivered by the delivering unit 150 and stores the information in the customer information storing unit 240 or the product information storing unit 250. Based on a customer identifier and product identifiers entered when a customer purchases products, the determining unit 270 refers to the customer information storing unit 240 and the product information storing unit 250, to thereby acquire allergy information for the customer and/or his/her family members and then provide the allergy information to the transaction control unit 230.

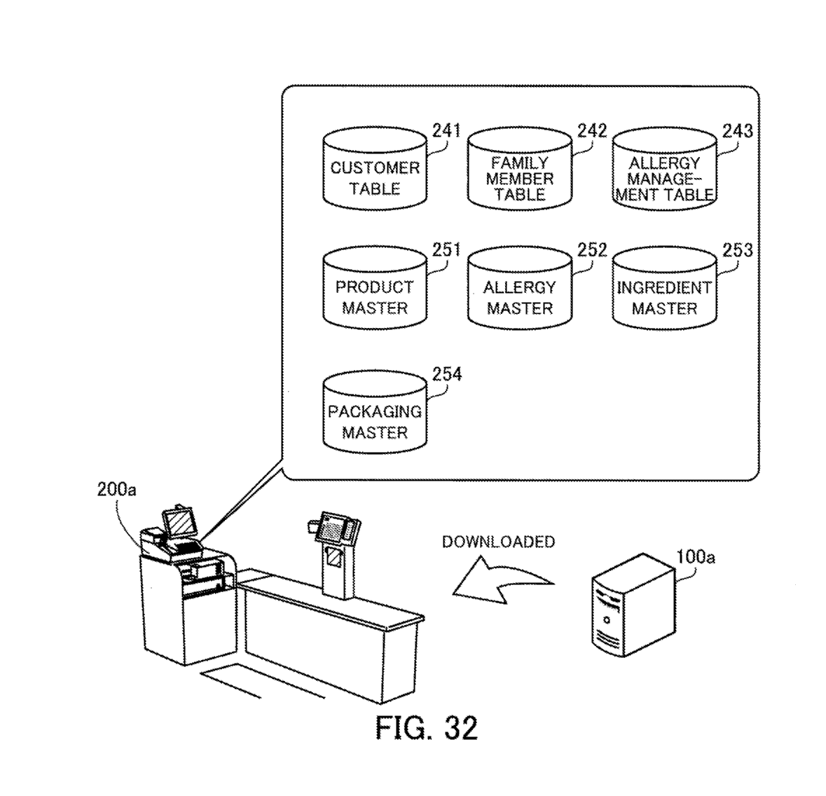

FIG. 32 illustrates examples of tables according to the third embodiment. The acquiring unit 260 downloads information stored in the customer information storing unit 110 from the management server 100a, and stores the information in the customer information storing unit 240. In addition, the acquiring unit 260 downloads information stored in the product information storing unit 120 from the management server 100a, and stores the information in the product information storing unit 250.

The customer information storing unit 240 stores therein a customer table 241, a family member table 242, and an allergy management table 243. Information registered in the customer table 241 is the same as that in the customer table 111. Information registered in the family member table 242 is the same as that in the family member table 112. Information registered in the allergy management table 243 is the same as that in the allergy management table 113. The product information storing unit 250 stores therein a product master 251, an allergy master 252, an ingredient master 253, and a packaging master 254. Information registered in the product master 251 is the same as that in the product master 121. Information registered in the allergy master 252 is the same as that in the allergy master 122. Information registered in the ingredient master 253 is the same as that in the ingredient master 123. Information registered in the packaging master 254 is the same as that in the packaging master 124.

That is, the information stored in the customer information storing unit 240 is synchronized by the acquiring unit 260 with the information stored in the customer information storing unit 110. In addition, the information stored in the product information storing unit 250 is synchronized by the acquiring unit 260 with the information stored in the product information storing unit 120.

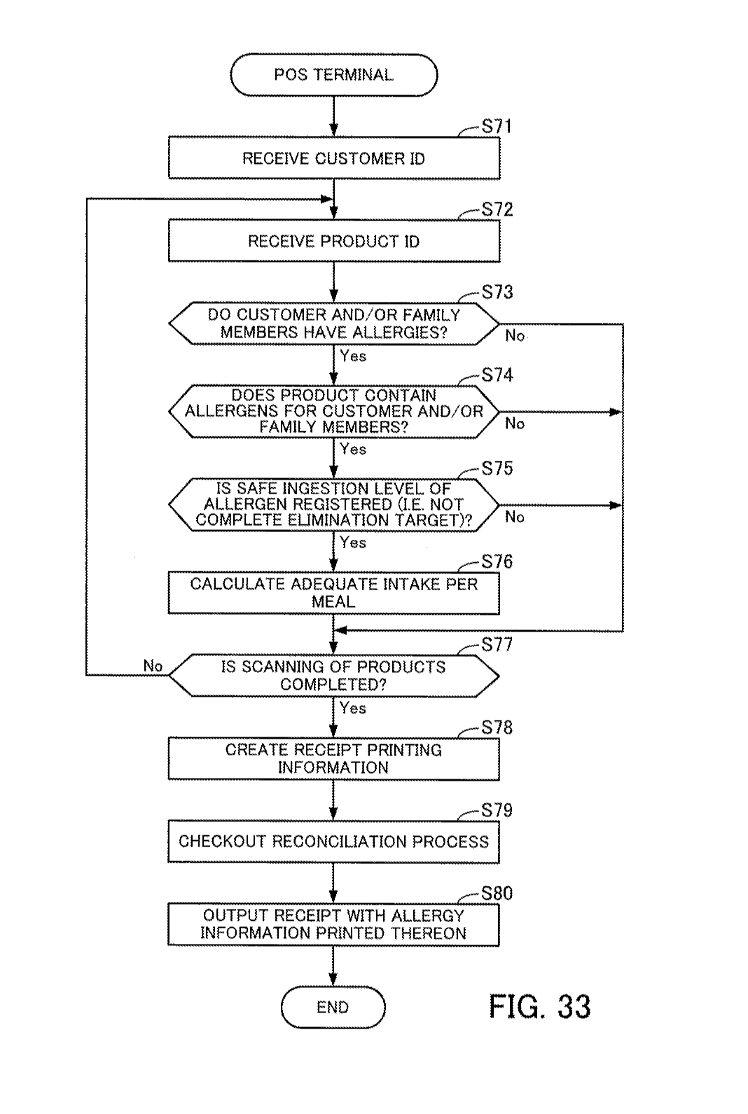

Next described is a checkout processing procedure of the POS terminal 200a. According to the third embodiment, the determining unit 270 of the POS terminal 200a performs the process carried out by the determining unit 130 in the second embodiment. FIG. 33 is a flowchart illustrating an example of a POS process according to the third embodiment. The process of FIG. 33 is described next according to the step numbers in the flowchart.

(Step S71) The transaction control unit 230 receives an input of a customer identifier at the start of a checkout process for purchases of products. For example, a shop assistant receives an integrated circuit card owned by a customer from the customer and inserts the card into the card reader 24, which then reads the customer identifier on the integrated circuit card. Subsequently, the transaction control unit 230 receives the customer identifier read by the card reader 24. The transaction control unit 230 informs the determining unit 270 of the customer identifier.

(Step S72) The transaction control unit 230 receives a product identifier of a product for purchase by the customer. For example, the shop assistant scans a barcode label on the product using the scanner 26a or 26b. The barcode label contains the product identifier, and the scanner 26a or 26b reads the product identifier from the barcode label and outputs it to the POS terminal 200a. The transaction control unit 230 subsequently receives the product identifier read by the scanner 26a or 26b. The shop assistant may enter the product identifier into the POS terminal 200a using the touch panel on the display 26c or the input device 27. The transaction control unit 230 sends the product identifier to the management server 100a. Based on the product master 251 stored in the POS storing unit 220, the transaction control unit 230 calculates the total sum of currently entered products for purchase and updates the display of the product registration screen image G60. The transaction control unit 230 informs the determining unit 270 of the received product identifier.

(Step S73) With reference to the allergy management table 243, the determining unit 270 determines whether the customer and/or his family members corresponding to the customer identifier acquired in step S71 have allergies. If they have allergies, the process moves to step S74. If they do not have allergies, the process moves to step S77. Specifically, when “positive” is set in a field of the allergy status column in the allergy management table 243, the determining unit 270 determines that a corresponding person has an allergy. On the other hands, when “negative” is set in a field of the allergy status column in the allergy management table 243, the determining unit 270 determines that a corresponding person has no allergies. In the case where there is more than one individual to be determined, the determining unit 270 determines the allergy status of each of the individuals, and moves to step S74 if at least one of them is determined to have an allergy.

(Step S74) The determining unit 270 determines whether the product identified by the product identifier acquired in step S72 contains allergens for the customer and/or his/her family members. If the product contains allergens for the customer and/or his/her family members, the process moves to step S75. If the product contains no allergens for the customer and his/her family members, the process moves to step S77. The specific determination method here is the same as that of the determining unit 130 (step S33) illustrated in FIG. 24. Note however that the determining unit 270 makes the determination in step S74 based on the information stored in the customer information storing unit 240 and the product information storing unit 250.

(Step S75) With reference to the allergy management table 243, the determining unit 270 determines whether the allergen identified in step S74 is not specified as a complete elimination target for a corresponding individual and the safe ingestion level of the allergen for the person has been registered. If the allergen is not specified as a complete elimination target and the safe ingestion level of the allergen has been registered, the process moves to step S76. If the allergen is specified as a complete elimination target, the determining unit 270 stores, in the customer information storing unit 240, allergy information indicating that the identified allergen is a complete elimination target for the person, and then moves to step S77.

(Step S76) As for the allergen for the person, the determining unit 270 calculates the adequate intake of the product per meal based on the allergy management table 243 and the ingredient master 253. The specific calculation method here is the same as that of the determining unit 130 (step S36) illustrated in FIG. 24.

(Step S77) The transaction control unit 230 determines whether scanning of all products for purchase by the customer is completed. If it is completed, the process moves to step S78. If not, the process moves to step S72. For example, the shop assistant may input scanning completion to the POS terminal 200a using the input device 27. Upon receiving the input, the transaction control unit 230 determines the completion of the product scanning and notifies the determining unit 270 of the product scanning completion. Upon receiving the product scanning completion notice, the determining unit 270 provides the transaction control unit 230 with the allergy information acquired through the procedure in steps S73 to S76.

(Step S78) The transaction control unit 230 creates receipt printing information. The receipt printing information is information of the individual character strings on the receipt R1 illustrated in FIG. 21. Specifically, the receipt printing information includes a list of the products for purchase by the customer and their prices. In addition, the receipt printing information may include allergy information of the customer and/or his/her family members.

(Step S79) The transaction control unit 230 performs a checkout reconciliation process for the customer's purchases. The transaction control unit 230 adds, to the receipt printing information, the amount of money entered into and taken from the change machine 22 by the shop assistant.

(Step S80) Based on the receipt printing information, the transaction control unit 230 outputs the receipt R1 from the printer 25. The allergy information is printed on the receipt R1. Note however that in the case where none of the customer and his/her family members have food allergies, the transaction control unit 230 may output a receipt with no allergy information printed thereon from the printer 25.

In the above-described manner, the POS terminal 200a is able to issue the receipt R1 with the allergy information based on the information downloaded from the management server 100a to the POS terminal 200a. In this case, the POS terminal 200a need not communicate with the management server 100a to acquire the allergy information, thus reducing the load on the network 10 and further facilitating high-speed checkout reconciliation of purchased products. Note that the POS terminal 200a may acquire information on ingredients and allergens contained in individual products and the amount of each allergen contained therein not only from the management server 100a, but also from barcode labels and integrated circuit tags on products.

### (d) Fourth Embodiment

A fourth embodiment is described next. While omitting repeated explanations, the following description focuses on differences from the second embodiment above. The second embodiment illustrates the function of raising an alert mainly on allergens; however, the management server 100 may raise an alert on nutritional components, such as salt content, sugar content, protein, potassium, dietary fiber, and energy. In view of this, the fourth embodiment is directed to providing a function for the management server 100 to raise an alert on nutritional components.

According to the fourth embodiment, the customer information storing unit 110 stores therein a nutritional component management table 114 in addition to the customer table 111, the family member table 112, and the allergy management table 113. In addition, the product information storing unit 120 stores therein a nutritional component master 125 in addition to the product master 121, the allergy master 122, the ingredient master 123 and the packaging master 124.

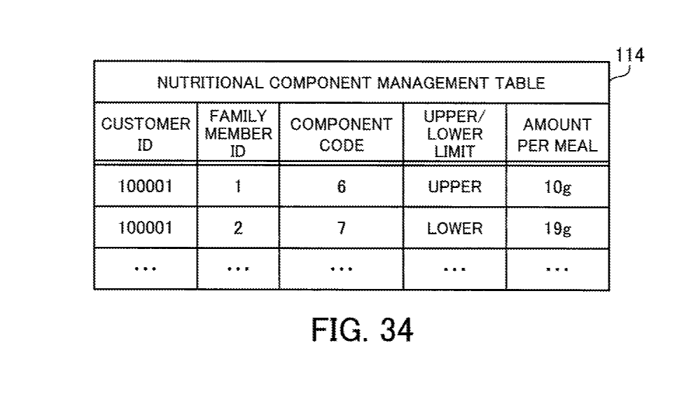

FIG. 34 illustrates an example of a nutritional component management table according to the fourth embodiment. The nutritional component management table 114 includes columns of the following items: customer identifier; family member identifier; component code; upper/lower limit; and amount per meal. Each field in the customer identifier column contains the customer identifier of a customer. Each field in the family member identifier column contains the family member identifier of a family member. Each field in the component code column contains the component code which is identification information of a management-target nutritional component for a person identified by the corresponding customer and family member identifiers. Each field in the upper/lower limit column contains the classification indicating whether its corresponding amount per meal represents an upper or lower intake limit per meal. The upper intake limit per meal is the upper limit of the corresponding nutritional component acceptable for the person to consume for each meal. In the case of, for example, a patient with hypertension, the upper limit of salt intake per meal may be set. In the case of a diabetic patient, the upper limit of sugar intake per meal may be set. The lower intake limit per meal is the lower limit of the corresponding nutritional component recommended for the person to consume for each meal. For example, the lower intake limits of nutritional components, such as potassium, dietary fiber, and calcium, per meal may be set for better health. Each field in the amount per meal column contains the value set as the upper or lower intake limit per meal.

For example, an entry with “100001” in the customer identifier field; “1” in the family member identifier field; “6” in the component code field; “upper” in the upper/lower limit field; and “10 g” in the amount per meal field is registered in the nutritional component management table 114. This entry indicates that, as for a family member with the family member identifier “1” of a customer who is identified by the customer identifier “100001”, the upper intake limit of a nutritional component with the component code “6” is “10 g” per meal.

In addition, for example, an entry with “100001” in the customer identifier field; “2” in the family member identifier field; “7” in the component code field; “lower” in the upper/lower limit field; and “19 g” in the amount per meal field is registered in the nutritional component management table 114. This entry indicates that, as for a family member with the family member identifier “2” of a customer who is identified by the customer identifier “100001”, the lower intake limit of a nutritional component with the component code “7” is “19 g” per meal.

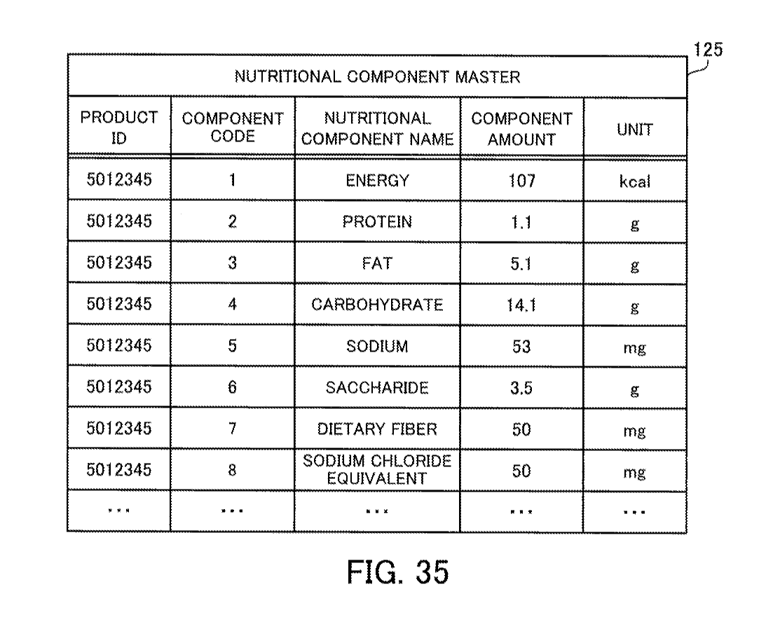

FIG. 35 illustrates an example of the nutritional component master according to the fourth embodiment. The nutritional component master 125 includes columns of the following items: product identifier; component code; nutritional component name; component amount; and unit. Each field in the product identifier column contains the product identifier of a product. Each field in the component code column contains the component code of a nutritional component. Each field in the nutritional component name column contains the name of a nutritional component. Each field in the component amount column contains the amount of a corresponding nutritional component (the component amount) per minimum unit of the contents of the product (for example, per cookie in the case where the product is cookies). Each field in the unit column contains the unit of the corresponding component amount.

For example, an entry with “5012345” in the product identifier field; “1” in the component code field; “energy” in the nutritional component name field; “107” in the component amount field; and “kcal (kilocalorie)” in the unit field is registered in the nutritional component master 125. This entry indicates that a product (chocolate chip cookies) with the product identifier “5012345” contains the nutritional component “energy” identified by the component code “1”, and the amount of energy per minimum unit (per chocolate chip cookie) is 107 kcal.

Next described is a processing procedure carried out by the management server 100 according to the fourth embodiment. The processing procedure of the POS terminal 200 is the same as that of the POS terminal 200 of the second embodiment, illustrated in FIG. 23. Note however that the POS terminal 200 of the fourth embodiment prints not allergy information, but nutritional component information of a customer and/or his/her family members on a receipt. The following illustrates a procedure for the management server 100 to provide the nutritional component information to the POS terminal 200.

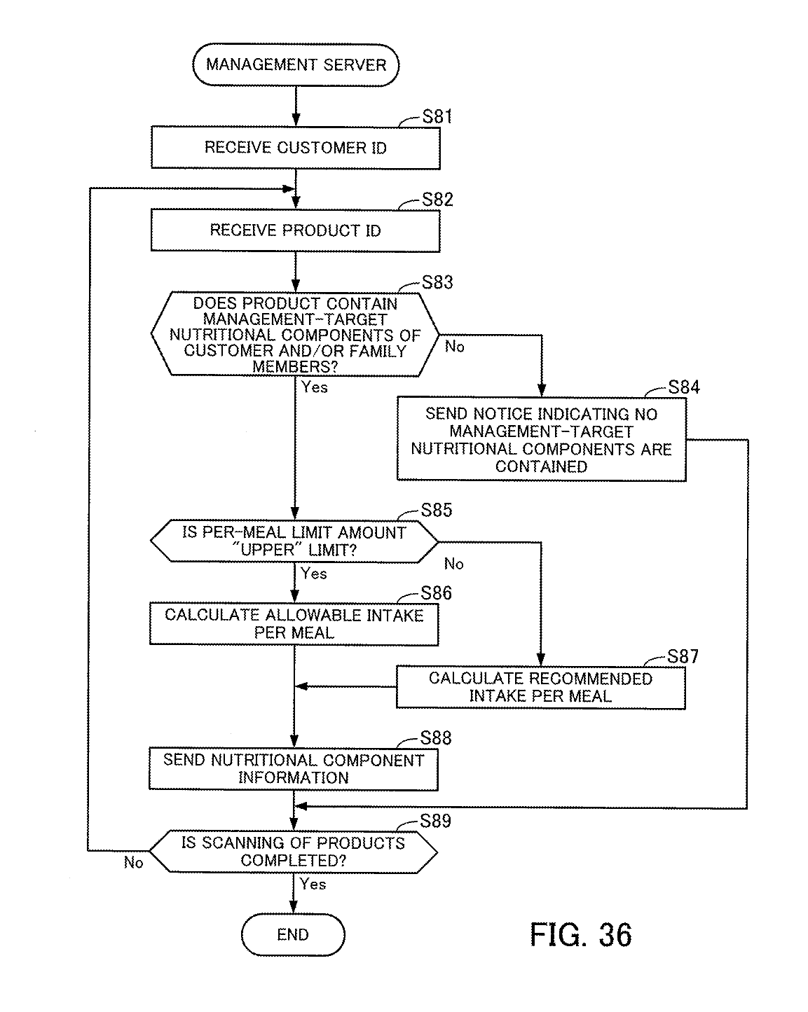

FIG. 36 is a flowchart illustrating an example of providing nutritional component information according to the fourth embodiment. The process of FIG. 36 is described next according to the step numbers in the flowchart.

(Step S81) The determining unit 130 receives a customer identifier from the POS terminal 200.

(Step S82) The determining unit 130 receives a product identifier from the POS terminal 200.

(Step S83) The determining unit 130 determines whether a product identified by the product identifier received in step S82 contains a management-target nutritional component of a customer and/or his/her family members. If the product contains no management-target nutritional component of the customer and his/her family members, the process moves to step S84. If the product contains a management-target nutritional component of the customer and/or his/her family members, the process moves to step S85. Specifically, based on the nutritional component management table 114 and the nutritional component master 125, the determining unit 130 acquires information on management-target nutritional components of a customer corresponding to the customer identifier received in step S81 and his/her family members. Further, based on the nutritional component master 125, the determining unit 130 determines whether, amongst ingredients corresponding to the product identifier received in step S82, there is an ingredient containing a management-target nutritional component of the customer and/or his/her family members. Finding such an ingredient indicates that the product identified by the product identifier received in step S82 contains a management-target nutritional component of the customer and/or his/her family members. On the other hand, if the ingredients corresponding to the product identifier contains no management-target nutritional components of the customer and his/her family members, the product identified by the product identifier received in step S82 contains no management-target nutritional component of the customer and his/her family members.

(Step S84) The determining unit 130 sends, to the POS terminal 200, a notice indicating that no management-target nutritional components are contained in the product identified by the product identifier received in step S82. Then, the process moves to step S89.

(Step S85) With reference to the nutritional component management table 114, the determining unit 130 determines whether the per-meal limit amount of the management-target nutritional component identified in step S83 is an upper limit. If it is an upper limit, the process moves to step S86. If not (i.e., it is a lower limit), the process moves to step S87. Specifically, the per-meal limit amount is an upper limit if “upper” is set in the corresponding upper/lower limit field of the nutritional component management table 114. On the other hand, the per-meal limit amount is a lower limit if “lower” is set therein.

(Step S86) As for the management-target nutritional component of the person, the determining unit 130 calculates an allowable intake of the product per meal based on the nutritional component management table 114 and the nutritional component master 125. The allowable intake is calculated in the same manner as calculating the adequate intake illustrated in step S36 of FIG. 24. Assume here that the customer “Hanako Fujitsu” (the customer identifier “100001”) purchases the product “chocolate chip cookies” (the product identifier “5012345”). According to the nutritional component management table 114 and the nutritional component master 125, the product “chocolate chip cookies” contains “saccharide” which is a management-target nutritional component of the family member “Taro Fujitsu” (the family member identifier “1”) of the customer “Hanako Fujitsu”. According to the nutritional component master 125, each cookie of the product “chocolate chip cookies” contains 3.5 g of “saccharide”. According to the nutritional component management table 114, the upper limit of “saccharide” for “Taro Fujitsu” per meal is 10 g. The determining unit 130 calculates the following equation, 10 (g)÷3.5 (g/cookie)=2.86 (cookies), and returns the largest integer not exceeding 2.86, i.e., 2, as the allowable intake for “Taro Fujitsu”. If the management-target nutritional component weight included in the minimum unit amount of the contents of the product exceeds the upper limit for the person per meal, the determining unit 130 returns “0” as the allowable intake of the product. Then, the process moves to step S88.

(Step S87) As for the management-target nutritional component of the person, the determining unit 130 calculates a recommended intake of the product per meal based on the nutritional component management table 114 and the nutritional component master 125. Assume here that the customer “Hanako Fujitsu” purchases a product containing 5 g of “dietary fiber” per minimum unit of the contents of the product (information indicating the product contains 5 g of dietary fiber per minimum unit of the contents of the product is registered in the nutritional component master 125 in association with the product identifier of the product). According to the nutritional component management table 114, “dietary fiber” is a management-target nutritional component of “Jiro Fujitsu” (the family member identifier “2”) and the lower limit of “dietary fiber” per meal is 19 g. Accordingly, the determining unit 130 calculates the following equation, 19 (g)÷5 (g/piece)=3.8 (pieces), and returns the smallest integer exceeding 3.8, i.e., 4, as the recommended intake for “Jiro Fujitsu”. Then, the process moves to step S88.

(Step S88) The determining unit 130 sends, to the POS terminal 200, nutritional component information including the allowable intake of the management-target nutritional component calculated in step S86 or the recommended intake of the management-target nutritional component calculated in step S87.

(Step S89) The determining unit 130 determines whether scanning of all products for purchase by the customer is completed. If it is completed, the process ends. If not, the process moves to step S82. Specifically, upon receiving a product scanning completion notice from the POS terminal 200, the determining unit 130 determines the completion of the product scanning.

Note that, in step S83, a management-target nutritional component may be identified for more than one individual among the customer and his/her family members. In such a case, the determining unit 130 runs steps S85, S86, and S87 for each person. Then, the determining unit 130 sends, in step S88, nutritional component information for each of the individuals to the POS terminal 200. Further, in step S83, a plurality of management-target nutritional components of the product may be identified for one person. In this case, the determining unit 130 runs steps S85, S86, and S87 for each of the management-target nutritional components. In step S85, if the allowable intake of at least one of the management-target nutritional components is “0”, the determining unit 130 sets “0” as the allowable intake of the product for the person.

Note that the management server 100 may run the procedure of FIG. 36 together with the provision of the allergy information illustrated in FIG. 24. The POS terminal 200 acquires the allergy information and the nutritional component information from the management server 100 and prints them on a receipt. In this case, if there is a product related to both an adequate intake (“first value”) associated with the allergy information and an allowable intake (“second value”) associated with the nutritional component information, the determining unit 130 sets the smaller one of the first and second values as the adequate intake of the product. Assume that, as for the product “chocolate chip cookies”, the allergy information indicates that the adequate intake for a person is two cookies while the nutritional component information indicates that the allowable intake for the person is three cookies. In this case, the determining unit 130 may output the adequate intake of two cookies associated with the allergy information as the adequate intake of the product for the person.

In addition, if there is a product related to both an adequate intake associated with the allergy information and a recommended intake associated with the nutritional component information, the determining unit 130 outputs an adequate intake of the product depending on the magnitude relationship between the two intake values. As the first example, assume that, as for the product “chocolate chip cookies”, the allergy information indicates that the adequate intake for a person is two cookies while the nutritional component information indicates that the recommended intake for the person is three cookies (i.e., the adequate intake associated with the allergy information is below or equal to the recommended intake associated with the nutritional component information). In this case, the determining unit 130 may output the adequate intake of two cookies associated with the allergy information as the adequate intake of the product for the person. As the second example, assume that, as for the product “chocolate chip cookies”, the allergy information indicates that the adequate intake for a person is five cookies while the nutritional component information indicates that the recommended intake for the person is two cookies (i.e., the adequate intake associated with the allergy information exceeds the recommended intake associated with the nutritional component information). In this case, the determining unit 130 may output the range of “two (the recommended intake associated with the nutritional component information) to five (the adequate intake associated with the allergy information) cookies” as the adequate intake of the product for the person.

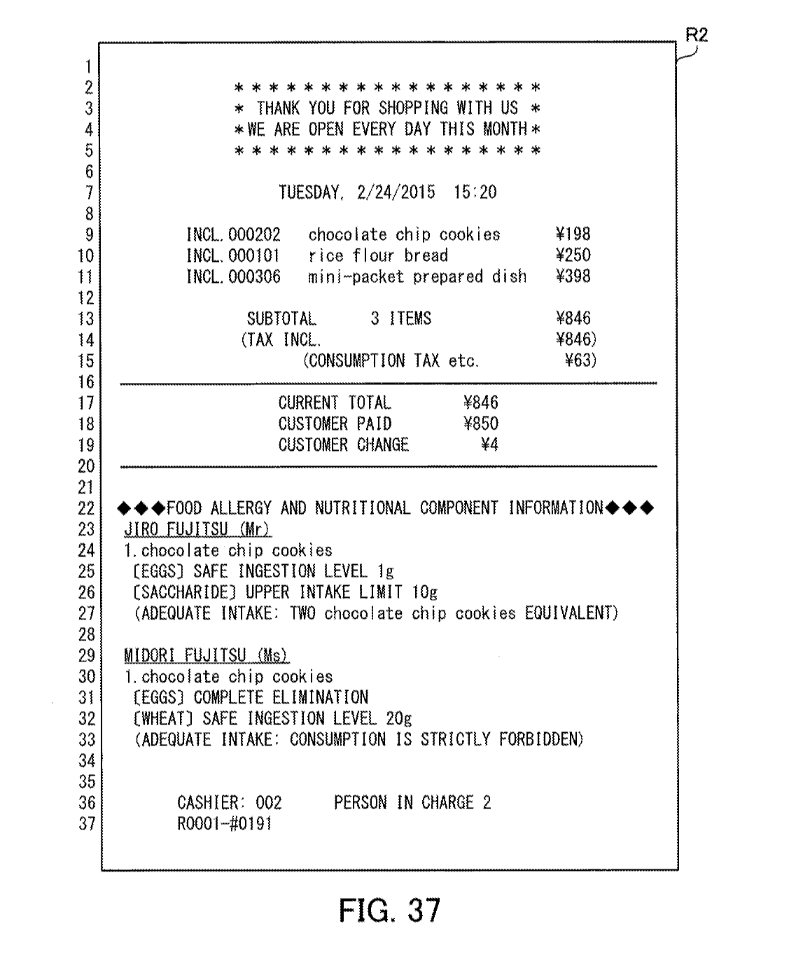

FIG. 37 illustrates a print sample of a receipt according to the fourth embodiment. A receipt R2 is issued by the POS terminal 200 using the printer 25. The receipt R2 includes, in addition to the character strings illustrated in the receipt R1, character strings representing nutritional component intake information, which is, in the example of the receipt R2, a character string saying “[SACCHARIDE] UPPER INTAKE LIMIT 10 g” in line 26. In addition, a character string saying “(ADEQUATE INTAKE: TWO chocolate chip cookies EQUIVALENT)” in line 27 of the receipt R2 indicates the adequate intake of the product obtained after taking into account both the adequate intake associated with the allergy information and the allowable intake associated with the nutritional component information, as described above.

Some customers may be on dietary restrictions (restrictions on salt content, sugar content, protein, potassium, energy, and the like) due to their medical conditions. Such a customer needs to refer to a food label on a food product concerned and then calculate on his/her own how much of his/her allowed daily intake of a specific nutritional component that the food product provides, which takes a lot of effort and time of the customer. Therefore, the use of the management server 100 allows for an appropriate alert on the amount of intake of a product for purchase by the customer when the product contains a management-target nutritional component of the customer. The appropriate alert allows the customer to easily understand the allowable intake of the product and, therefore, casually enjoy their meals with ease. Thus, the fourth embodiment is able to ease the burden on customers and contribute to improving the quality of their lives. In addition, the provision of the recommended intake of a product contributes to better health of each customer. As illustrated in the receipt R2 above, an even more appropriate alert for the intake of a product is given by providing the customer with the adequate intake of the product obtained by considering not only the allergy information but also nutritional component information.

According to the above-described example, the management server 100 provides, to the POS terminal 200, the allergy information and nutritional component information for a customer purchasing products and his/her family members; however, the management server 100 may provide the allergy information and nutritional component information for people other than the family members of the customer. For example, identifiers of friend close to the customer and identifiers of non-family members for which the customer provides care and their allergy-related information may be registered in the management server 100 in association with the customer identifier of the customer. In this case, in response to entry of the customer identifier and product identifiers, the management server 100 provides allergy information and nutritional component information for such people outside the family.

In addition, the POS terminal 200 may allow a customer to enter a customer ID of another customer using a touch panel (or a different input device) on the display 26e for customer use and send the received customer identifier to the management server 100. Then, in response to entry of the customer identifier and product identifiers, the management server 100 provides allergy information and nutritional component information for the other customer.

Note that the information processing of the first embodiment is implemented by causing the calculating unit 1b to execute a program. Also, the information processing of the second and fourth embodiments is implemented by causing the processor 101 to execute a program. The information processing of the third embodiment is implemented by causing a processor of the POS terminal 200a (which is considered to include a computer with memory and the processor) to execute a program. Such a program may be recorded in the computer-readable storage medium 13. For example, the storage media 13 on which the program is recorded are distributed in order to deliver the program to individual recipients. In addition, the program may be stored in a different computer and then distributed via a network. A computer stores, or installs, the program recorded in the storage medium 13 or received from the different computer in a storage device, such as the RAM 102 or the HDD 103, and reads the program from the storage device to execute it.

According to one aspect, when a product for purchase by a customer contains allergens, an appropriate alert on the amount of intake is given to the customer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A product purchase processing method comprising:
acquiring identification information of a target customer and product information of one or more products for purchase by the target customer;
specifying, with reference to customer information stored in a memory, an allergen and allergen ingestion restriction information about a restriction on ingestion of the allergen, the allergen and the allergen ingestion restriction information being stored in association with the identification information of the target customer; and
outputting, when the one or more products include a product containing the allergen, product intake restriction information about a restriction on intake of the product based on the allergen ingestion restriction information.

2. The product purchase processing method of claim 1, further comprising:
printing the product intake restriction information on a receipt with the product information of the one or more products printed thereon.

3. The product purchase processing method of claim 1, wherein:
the customer information includes information about an allergen for a family member of the target customer and information about a restriction on ingestion of the allergen for the family member, and
the outputting includes outputting, based on the customer information, the product intake restriction information for each of the target customer and the family member of the target customer.

4. The product purchase processing method of claim 1, wherein:
the outputting includes outputting an acceptable intake amount out of net weight of the product based on the allergen ingestion restriction information and allergen content information about an amount of the allergen contained in contents of the product.

5. The product purchase processing method of claim 4, wherein:
the allergen content information includes, when the contents of the product are divided into smaller units, an amount of the allergen contained in each of the smaller units of the product, and
the outputting includes outputting the acceptable intake amount also based on information about an amount of contents contained in each of the smaller units of the product.

6. The product purchase processing method of claim 4, wherein:
the outputting includes outputting the acceptable intake amount represented in quantity, volume, mass, weight, or a percentage of the contents.

7. The product purchase processing method of claim 4, wherein:
the outputting includes determining, based on the allergen ingestion restriction information, whether the product is a complete elimination target which the target customer is not allowed to consume, and outputting a notice indicating that the target customer is not allowed to consume the product when the product is the complete elimination target and outputting the acceptable intake amount when the product is not the complete elimination target.

8. The product purchase processing method of claim 1, wherein:
the acquiring the allergen ingestion restriction information includes acquiring, with reference to the customer information, also a nutritional component and nutritional component intake restriction information about a restriction on intake of the nutritional component, the nutritional component and the nutritional component intake restriction information being stored in association with the identification information, and
the outputting includes outputting the product intake restriction information based on the allergen ingestion restriction information and the nutritional component intake restriction information.

9. A product purchase processing apparatus comprising:
a memory that stores an allergen and allergen ingestion restriction information about a restriction on ingestion of the allergen in association with identification information of each customer; and
a processor operatively coupled to the memory, the processor being configured to perform a procedure including:
acquiring identification information of a target customer and product information of one or more products for purchase by the target customer,
specifying, with reference to the memory, the allergen and the allergen ingestion restriction information stored in association with the identification information of the target customer, and
outputting, when the one or more products include a product containing the allergen, product intake restriction information about a restriction on intake of the product based on the allergen ingestion restriction information.

10. A non-transitory computer-readable storage medium storing a product purchase processing program that causes a computer to perform a process comprising:
acquiring identification information of a target customer and product information of one or more products for purchase by the target customer;
specifying, with reference to customer information stored in a memory, an allergen and allergen ingestion restriction information about a restriction on ingestion of the allergen, the allergen and the allergen ingestion restriction information being stored in association with the identification information; and
outputting, when the one or more products include a product containing the allergen, product intake restriction information about a restriction on intake of the product based on the allergen ingestion restriction information.
